(19) United States
(12) Patent Application Publication
(10) Pub. No.: US 2026/0045716 A1
(43) Pub. Date: Feb. 12, 2026

(54) RELIABLE HIGH-SPEED, HIGH-CURRENT ELECTRICAL CONNECTOR

(71) Applicant: FCI Nantong Ltd., Nantong (CN)

(72) Inventors: Liqing Lei, Nantong (CN); Zelin Yao, Nantong (CN); Shoukun Zhu, Nantong (CN)

(73) Assignee: FCI Nantong Ltd., Nantong (CN)

(21) Appl. No.: 19/360,749

(22) Filed: Oct. 16, 2025

Related U.S. Application Data
(63) Continuation of application No. PCT/CN2023/117245, filed on Sep. 6, 2023.

(30) Foreign Application Priority Data
Apr. 19, 2023 (CN) 202320882509.8

(51) Int. Cl. H01R 12/70; H01R 12/58; H01R 12/72; H01R 13/24

(52) U.S. Cl. CPC H01R 12/7047; H01R 12/58; H01R 12/7052; H01R 12/721; H01R 13/2442

(57) ABSTRACT

Electrical connectors configured to provide power and/or high-speed signal connections with a compact form factor. A connector includes a housing holding closely spaced signal terminals arranged in one or more rows and power terminals disposed at row ends. The power terminals extend generally perpendicular to the signal-terminal rows, with blade-shaped mounting portions. The power mating portions can be configured for clamping engagement with corresponding power terminals of a mating connector. The housing includes a slot or tongue portion, with signal terminals lining the slot or tongue portion, with blade-shaped or beam-shaped mating portions. The housing further includes a locking portion configured to receive a portion of a locking member and a holding or retaining member configured to secure the locking member and enhance mechanical attachment. Such a configuration can enable reliable electrical and mechanical coupling between boards or mating connectors without increasing connector height or width.

### CROSS-REFERENCE TO RELATED APPLICATIONS

This application is a continuation of International Application No. PCT/CN2023/117245, filed on Sep. 6, 2023, entitled “RELIABLE FINE PITCH BOARD-TO-BOARD CONNECTORS FOR LARGE CURRENT AND HIGH SPEED,” which claims priority to and the benefit of Chinese Patent Application No. 202320882509.8, filed on Apr. 19, 2023. The contents of these applications are incorporated herein by reference in their entirety.

### TECHNICAL FIELD

The present disclosure generally relates to interconnection systems, such as those including electrical connectors, used to interconnect electronic assemblies.

### BACKGROUND

Electrical connectors are used in many electronic systems. In general, various electronic devices (e.g., smart phones, tablet computers, desktop computers, notebook computers, digital cameras, and the like) have been provided with assorted types of connectors whose primary purpose is to enable an electronic device to exchange data, commands, and/or other signals with one or more other electronic devices. Electrical connectors are basic components needed to make some electrical systems functional. Signal transmission to transfer information (e.g., data, commands, and/or other electrical signals) often utilize electrical connectors between electronic devices, between components of an electronic device, and between electrical systems that may include multiple electronic devices.

It is generally easier and more cost effective to manufacture an electrical system as separate electronic assemblies, such as printed circuit boards (“PCBs”), which may be communicatively joined together with electrical connectors. In some scenarios, the PCBs to be joined may each have connectors mounted on them. The connectors may be mated together directly to interconnect the PCBs.

In other scenarios, the PCBs may be connected indirectly via a cable. Electrical connectors may nonetheless be used to make such connections. For example, the cable may be terminated on one or both ends with a plug type of electrical connector (“plug connector” or “male connector” herein). A PCB may be equipped with a receptacle type of electrical connector (“receptacle connector” or “female connector” herein) into which the plug connector may be inserted to connect the cable to the PCB. A similar arrangement may be used at the other end of the cable, to connect the cable to another PCB, so that signals may pass between the PCBs via the cable.

### SUMMARY

Aspects of the present application relate to reliable high-speed, high-current electrical connectors.

Some embodiments relate to an electrical connector. The electrical connector may include a housing comprising an elongated portion; a plurality of signal terminals held by the elongated portion of the housing in a row, each of the plurality of signal terminals comprising a mating portion, a mounting portion, and an intermediate portion between the mating portion and the mounting portion; the elongated portion of the housing comprises a wall comprising a plurality of channels; the plurality of signal terminals are disposed in respective channels of the plurality of channels; and each of the plurality of channels comprises a gap between a respective signal terminal and the wall, the gap extending beyond the intermediate portion of the respective signal terminal.

Optionally, the electrical connector comprises a first power terminal disposed at a first end of the plurality of signal terminals; and a second power terminal disposed at a second end of the plurality of signal terminals, the second end opposite the first end, wherein the first and second power terminals extend in parallel to each other and perpendicular to the row.

Optionally, the housing comprises first and second end portions on opposite ends of the elongated portion, each of the first and second end portions comprising a slot elongated in a direction perpendicular to the row; and the first and second power terminals are held in the slots of the first and second end portions of the housing, respectively.

Optionally, each of the first and second end portions are shaped asymmetrically relative to a longitudinal central plane of the housing.

Optionally, each of the first and second power terminals comprises a blade-shaped mounting portion, and a mating portion configured for clamping engagement with a mating portion of a mating connector.

Optionally, the mating portion of each of the first and second power terminals comprises a plurality of beams configured to clamp with a blade of the mating connector.

Optionally, the housing comprises one or more locking portions each configured to receive a locking member.

Optionally, the one or more locking portions comprise a locking portion disposed within the elongated portion.

Optionally, the one or more locking portions comprise a locking portion disposed at an end of the elongated portion.

Optionally, the electrical connector comprises one or more holding members each corresponding to a respective locking portion of the one or more locking portions of the housing, the one or more holding members configured to retain respective locking members received in the corresponding locking portions.

Optionally, the electrical connector comprises the locking member comprising a head, a threaded portion, and a connecting portion between the head and the threaded portion, the threaded portion having a diameter greater than that of the connecting portion.

Some embodiments relate to an electrical connector. The electrical connector may include a housing comprising an elongated portion comprising a slot, and a locking portion comprising a through-hole; a plurality of signal terminals comprising mating portions lining against the slot in a row, mounting portions extending beyond the housing; and a retaining member at least partially disposed in the through-hole of the locking portion of the housing.

Optionally, the retaining member comprises a nut disposed in the through-hole.

Optionally, the locking portion is an overhanging portion of the housing.

Optionally, the locking portion separates the slot of the elongated portion into two segments.

Optionally, the retaining member comprises a cover extending along a mating face of the locking portion of the housing and comprising mounting feet configured for mounting to a circuit board.

Some embodiments relate to an electrical connector. The electrical connector may include a housing comprising a base, a tongue portion protruding from the base, and a locking portion comprising a through-hole; a plurality of signal terminals comprising mating portions lining against the tongue portion in a row, mounting portions extending beyond the base; and a locking feature extending in the through-hole of the locking portion of the housing.

Optionally, the through-hole of the locking portion of the housing is configured to receive a locking member; and the locking feature is configured to restrain movements of the locking member.

Optionally, the locking feature is a beam curved in the through-hole from a conductive member disposed on the locking portion of the housing.

Optionally, the locking portion is an insulative beam integrally formed with the housing.

Some embodiments relate to an electrical connector, such as a compact electrical connector. The electrical connector may include a group of signal terminals configured for transmitting high-speed electrical signals and a group of power terminals configured for transmitting large electrical currents. The electrical connector may include a locking structure configured for assembling with a PCB to facilitate stable and reliable connection between the electrical connector and the PCB and/or between electrical connectors.

Some embodiments relate to an electrical connector. The electrical connector may include an insulative housing having a base portion and a tongue portion, the base portion having a first side and a second side opposing the first side along a heightwise direction of the housing, the tongue portion extending from the second side, the first side configured to be connected to a PCB; a group of signal terminals provided in the housing, the group of signal terminals including a plurality of signal terminals spaced from each other along a lengthwise direction of the housing, and the signal terminals at least partially projecting and exposed from the tongue portion; a locking portion provided in the housing and configured to prevent a locking member from inadvertently releasing from the electrical connector after the locking member has passed in sequence the PCB and the locking portion.

Optionally, the locking portion is integrally formed together with the base portion of the housing, and has a through hole extending along the heightwise direction of the housing to enable the locking member to pass the through hole.

Optionally, the locking member is a threaded piece, and has a head, a connecting portion extending from the head, and a threaded portion located at a free end of the connecting portion, the head has an external diameter which is greater than the connecting portion and the threaded portion, and the threaded portion has an external diameter which is greater than the connecting portion.

Optionally, during the threaded piece passing in sequence the PCB and the locking portion, only the connecting portion and the threaded portion can pass the through hole of the locking portion.

Optionally, the electrical connector further comprises a holding member for installation to the locking portion to prevent the locking member from inadvertently releasing from the electrical connector.

Optionally, the locking portion has a first side, which is parallel to or coplanar with the first side of the base portion, and a second side which is parallel to or coplanar with the second side of the base portion, and the through hole of the locking portion extends from the first side to the second side of the locking portion.

Optionally, the holding member comprises a body portion for contacting the second side of the locking portion and a cantilever extending from the body portion and located in the through hole of the locking portion, and a free end of the cantilever is provided with an anti-release curved part.

Optionally, the holding member comprises two flanks extending from the body portion in the same direction as the cantilever, the locking portion includes two clamping slots disposed respectively at both sides of the locking portion along a widthwise direction of the housing, and the two flanks are configured to be clamped into the respective clamping slots.

Optionally, a mounting portion extends from a free end of each flank, and the mounting portion is exposed on the first side of the base portion and is configured to be attached onto the PCB.

Optionally, during the threaded portion passing the through hole of the locking portion, the threaded portion comes into contact with the anti-release curved part such that the cantilever deflects radially outwards, and after the threaded portion has gone over the anti-release curved part, the cantilever deflects radially inwards to return to its initial state.

Optionally, the locking portion is provided at one or either end of the housing along the lengthwise direction.

Optionally, the base portion comprises two base portions, the tongue portion comprises two tongue portions, and the locking portion is located between the two base portions.

Optionally, the locking portion is integrally formed with a cantilever, the cantilever extends in the through hole such that it is parallel to a central axis of the through hole, and the cantilever is formed with an anti-release bump at a free end thereof, which anti-release bump extends radially inwards.

Optionally, the cantilever comprises two cantilevers which are radially-symmetrical relative to the central axis of the through hole.

Optionally, in an unstressed state, a distance measured between two anti-release bumps of the two cantilevers is slightly less than the diameter of the threaded portion of the locking member but is greater than a diameter of the connecting portion of the locking member.

Optionally, during the threaded portion passing the through hole of the locking portion, the threaded portion comes into contact with the anti-release curved part such that the cantilever deflects radially outwards, and after the threaded portion has gone over the anti-release curved part, the cantilever deflects radially inwards to return to its initial state.

Optionally, a threaded through member is non-rotatably installed in the locking portion, and the threaded through member has a hollow first section and a second section to constitute the through hole of the locking portion.

Optionally, a threaded hole is formed in the first section, the threaded hole has internal threads which are configured to engage with external threads of the threaded portion of the locking member, and the second section has an internal diameter which is greater than the diameter of the threaded portion of the locking member.

Optionally, the threaded through member is harder than the housing of the electrical connector.

Optionally, during the threaded portion passing the through hole of the locking portion, the threaded portion is screwed to engage with the threaded hole of the first section to pass the first section.

Optionally, a cover is installed to the locking portion.

Optionally, the locking portion has a first side, which is parallel to or coplanar with the first side of the base portion, and a second side which is parallel to or coplanar with the second side of the base portion, the cover has a body portion in contact with the second side of the locking portion, a through hole is formed in the body portion to have an internal diameter which is greater than the threaded portion but is less than the second section, and the through hole of the body portion is coaxial with the through hole of the locking portion.

Optionally, the cover also comprises two flanks which extend respectively from two edges of the body portion substantially perpendicular to the body portion.

Optionally, the locking portion is formed with two receiving slots on both sides along a widthwise direction of the housing to receive the two flanks respectively.

Optionally, a mounting portion extends substantially perpendicularly from a free end of each flank to be exposed at the first side of the housing and thus be attached onto the PCB.

Optionally, the tongue portion is configured to receive a groove of another electrical connector or be received by the groove of said another electrical connector, complementary features are provided between the tongue portion and the groove such that the tongue portion can receive the groove of said another electrical connector or be received by the groove of said another electrical connector in a specific orientation only.

Optionally, the complementary features comprise a periphery contour of the tongue portion which is formed asymmetrically relative to a longitudinal central plane of the housing.

Optionally, the complementary features comprise a contact protrusion or a receiving recess formed in the tongue portion, and the contact protrusion or the receiving recess is provided asymmetrically relative to a longitudinal central plane of the housing.

Optionally, a plurality of signal terminal channels are defined in the housing to receive the plurality of signal terminals therein, wherein each signal terminal has an intermediate portion received in a corresponding one of the signal terminal channels, and a mounting portion bent relative to the intermediate portion and exposed at the first side of the base portion, wherein each signal terminal channel has a channel gap formed adjacent to the first side of the base portion such that a face of the respective intermediate portion departing away from the respective mounting portion is separated from the signal terminal channel.

Optionally, the electrical connector further comprises a group of power terminals provided in the housing.

Optionally, the group of power terminals comprises two power terminals which are at both ends of the group of signal terminals along the lengthwise direction of the housing.

Optionally, each power terminal comprises a substantially planar mounting portion and a clamping portion extending from an edge of the mounting portion.

Optionally, two power terminal channels are defined in the housing such that the two power terminals are installed in the two power terminal channels respectively.

Optionally, each power terminal channel is formed with opposing sidewalls to clamp the mounting portion of a respective power terminal therebetween.

Optionally, the clamping portion comprises four clamping portions which are spaced from each other in the widthwise direction of the housing and among which two clamping portions are on the outermost and two clamping portions are on the middle, wherein the two outermost clamping portions and the two middle clamping portions are respectively mirror-symmetrically curved relative to each other to define therebetween contact faces which are the closest to each other.

Some embodiments relate to an electrical connector. The electrical connector may include an insulative housing, the housing including a first side and a second side opposing the first side along a heightwise direction of the housing, the first side configured to be connected to a PCB, a groove formed in the housing, the groove opened at the second side; a group of signal terminals provided in the housing, the group of signal terminals including a plurality of signal terminals spaced from each other along a lengthwise direction of the housing and partially exposed in the groove; and a locking portion provided in the housing, a retaining member non-rotatably received in the locking portion to be screwed with a locking member, the locking member configured to pass another electrical connector provided at the second side and connected to the electrical connector to lock the two electrical connectors together.

Optionally, the locking portion is configured to overhang from the housing and is integrally formed therewith, and the locking portion has a cavity to receive the retaining member therein.

Optionally, the locking member is a threaded piece, and has a head, a connecting portion extending from the head, and a threaded portion located at a free end of the connecting portion, the head has an external diameter which is greater than the connecting portion and the threaded portion, and the threaded portion has an external diameter which is greater than the connecting portion.

Optionally, the threaded piece, only after passing said another electrical connector, is screwed with the retaining member.

Optionally, the locking portion has a first side substantially parallel to or coplanar with the first side of the housing, and the locking portion has a second side substantially parallel to or coplanar with the second side of the housing.

Optionally, the locking portion has a receiving cavity defined between the first side and the second side to receive the retaining member, and the receiving cavity is provided with an opening through which the retaining member is accessible.

Optionally, the opening of the receiving cavity faces outwards along or perpendicular to the lengthwise direction of the housing.

Optionally, the locking portion is provided at one end or either end of the housing along the lengthwise direction.

Optionally, the locking portion is located between both ends of the housing along the lengthwise direction.

Optionally, the opening of the receiving cavity faces outwards perpendicular to the lengthwise direction of the housing.

Optionally, a cavity is formed in the locking portion, and has an opening which is located in the second side and through which the retaining member is accessible.

Optionally, a cover is installed to the locking portion.

Optionally, the cover has a substantially planar body portion in contact with the locking portion, a through hole is formed in the body portion, and an internal diameter of the through hole is sized such that the threaded portion of the locking member is able to freely pass the through hole and that the retaining member is prevented from passing the body portion.

Optionally, the cover also comprises two flanks which extend from two edges of the body portion substantially perpendicular to the body portion.

Optionally, a mounting portion extends from a free end of each flank such that it is exposed at the first side of the housing to be attached to the PCB.

Optionally, the groove is configured to receive a tongue portion of another electrical connector, complementary features are provided between the groove and the tongue portion such that the groove can contain or receive the tongue portion in a specific orientation only.

Optionally, the complementary features comprise an inner contour of the groove which is formed asymmetrically relative to a longitudinal central plane of the housing.

Optionally, the complementary features comprise a receiving recess or a contact protrusion formed in the groove, which receiving recess or which contact protrusion is provided asymmetrically relative to a longitudinal central plane of the housing.

Optionally, a plurality of signal terminal channels are defined in the housing to receive the plurality of signal terminals therein, each signal terminal has an intermediate portion, and a mounting portion and a tip which are located at opposing ends of the intermediate portion, the mounting portion is bent relative to the intermediate portion, and each signal terminal is provided in a corresponding signal terminal channel such that the mounting portion is exposed on the first side of the housing and the tip is adjacent to the second side of the housing.

Optionally, each signal terminal channel has a first channel gap formed adjacent to the first side of the housing, through which first channel gap, a face of the intermediate portion facing outwards in the signal terminal channel is separated from a wall of the signal terminal channel.

Optionally, each signal terminal channel has a second channel gap formed in the second side of the housing, though which second channel gap, a face of the tip facing outwards in the signal terminal channel is separated from a wall of the signal terminal channel.

Optionally, the electrical connector further comprises a group of power terminals provided in the housing.

Optionally, the group of power terminals comprises two power terminals which are located at both ends of the group of signal terminals along the lengthwise direction of the housing.

Optionally, each power terminal is substantially planar, and comprises a mounting portion and an insertion portion extending from an edge of the mounting portion.

Optionally, two power terminal channels are defined in the housing to install the two power terminals respectively therein.

Optionally, each power terminal channel is in communication with the groove and is configured such that only the insertion portion of one power terminal is exposed in the groove when the power terminal is held in the power terminal channel.

Some embodiments relate to a locking structure configured for locking a first electrical connector, a PCB, and a second electrical connector together, the PCB installed on a first side of the first electrical connector, the second electrical connector connected to an opposing second side of the first electrical connector. The locking structure may include a threaded piece having a head, a rod portion extending from the head, and a threaded portion located at a free end of the connecting portion, the head having an external diameter which is greater than the connecting portion and the threaded portion, and the threaded portion having an external diameter which is greater than the connecting portion; and a retaining member non-rotatably provided in the second electrical connector, wherein the threaded portion of the threaded piece passes in sequence the PCB and the first electrical connector and is screwed with the retaining member to generate a locking force between the head and the retaining member to lock the PCB, the first electrical connector and the second electrical connector together.

Optionally, the first electrical connector has an insulative housing including a base portion and a tongue portion, the base portion has a first side and a second side opposing the first side along a heightwise direction of the housing, the tongue portion extends from the second side, the first side of the first electrical connector is defined by the first side of the base portion, and a locking portion is provided in the housing of the first electrical connector and is configured such that the threaded portion of the threaded piece, after passing in sequence the PCB and the locking portion, prevents the threaded piece from inadvertently releasing from the first electrical connector.

Optionally, the locking portion is integrally formed together with the base portion of the first electrical connector, and has a through hole which extends along the heightwise direction of the housing of the first electrical connector and through which the threaded piece passes.

Optionally, during the threaded piece passing in sequence the PCB and the locking portion, only the rod and the threaded portion pass the through hole of the locking portion.

Optionally, the locking structure further comprises a holding member installed to the locking portion to prevent the threaded piece from inadvertently releasing from the first electrical connector.

Optionally, the locking portion has a first side, which is parallel to or coplanar with the first side of the base portion, and a second side which is parallel to or coplanar with the second side of the base portion, and the through hole of the locking portion extends from the first side to the second side of the locking portion.

Optionally, the holding member comprises a body portion in contact with the second side of the locking portion and a cantilever extending from the body portion and located in the through hole of the locking portion, and a free end of the cantilever is provided with an anti-release curved part.

Optionally, the holding member comprises two flanks which extend from the body portion in the same direction as the cantilever, the locking portion comprises two clamping slots respectively located at both sides of the locking portion along a widthwise direction of the housing, and the two flanks are configured to be clamped in the clamping slots respectively.

Optionally, a mounting portion extends from a free end of each flank, and the mounting portion is exposed on the first side of the base portion and is configured to be attached o the PCB.

Optionally, during the threaded portion passing the through hole of the locking portion, the threaded portion comes into contact with the anti-release curved part such that the cantilever deflects radially outwards, and after the threaded portion has gone over the anti-release curved part, the cantilever deflects radially inwards to return to its initial state.

Optionally, the locking portion is provided at one end or either end of the housing of the first electrical connector along the lengthwise direction.

Optionally, the base portion comprises two base portions, the tongue portion comprises two tongue portions, and the locking portion is located between the two base portions.

Optionally, the locking portion is integrally formed with a cantilever which extends in the through hole parallel to a central axis thereof, and an anti-release bump extending radially inwards is formed at a free end of the cantilever.

Optionally, the cantilever comprises two cantilevers which are radially-symmetrical relative to the central axis of the through hole.

Optionally, in an unstressed state, a distance between two anti-release bumps of the two cantilevers is slightly less than the diameter of the threaded portion of the locking member but is greater than the diameter of the connecting portion of the locking member.

Optionally, during the threaded portion passing the through hole of the locking portion, the threaded portion comes into contact with the anti-release curved part such that the cantilever deflects radially outwards; and after the threaded portion has gone over the anti-release curved part, the cantilever deflects radially inwards to return to its initial state.

Optionally, a threaded through member is non-rotatably installed in the locking portion, and the threaded through member has a hollow first section and a second section to constitute the through hole of the locking portion.

Optionally, a threaded hole is formed in the first section, the threaded hole has internal threads which are configured to engage with external threads of the threaded portion of the locking member, and the second section has an internal diameter which is greater than the diameter of the threaded portion of the locking member.

Optionally, the threaded through member is harder than the housing of the electrical connector.

Optionally, during the threaded portion passing the through hole of the locking portion, the threaded portion is screwed to engage with the threaded hole of the first section to pass the first section.

Optionally, a cover is installed to the locking portion.

Optionally, the locking portion has a first side, which is parallel to or coplanar with the first side of the base portion, and a second side which is parallel to or coplanar with the second side of the base portion, the cover has a body portion in contact with the second side of the locking portion, a through hole is formed in the body portion and has an internal diameter which is greater than the threaded portion but is less than the second section, and the through hole of the body portion is coaxial with the through hole of the locking portion.

Optionally, the first cover also comprises two flanks which extend respectively from two edges of the body portion substantially perpendicular to the body portion.

Optionally, the locking portion is formed with two receiving slots on both sides along the widthwise direction of the housing to receive the two flanks respectively.

Optionally, a mounting portion extends substantially perpendicularly from a free end of each flank to be exposed at the first side of the housing and thus be attached onto the PCB.

Optionally, the second electrical connector comprises an insulative housing, the housing has a first side and a second side opposing the first side along the heightwise direction of the housing, the first side is configured to be connected to an additional PCB, a groove is formed in the housing and is opened at the second side, the locking portion is formed in the housing of the second electrical connector, and the retaining member is non-rotatably received in the locking portion.

Optionally, the locking portion overhangs from and is integrally formed together with the housing of the second electrical connector, and the locking portion has a cavity to receive the retaining member therein.

Optionally, the locking portion has a first side, which is substantially parallel to or coplanar with the first side of the housing of the second electrical connector, and a second side which is substantially parallel to or coplanar with the second side of the housing of the second electrical connector.

Optionally, the locking portion has a receiving cavity defined between the first and second sides to receive the retaining member, and the receiving cavity is provided with an opening through which the retaining member is accessible.

Optionally, the opening of the receiving cavity faces outwards along or perpendicular to the lengthwise direction of the housing of the second electrical connector.

Optionally, the locking portion is provided at one end or either end of the housing of the second electrical connector along the lengthwise direction.

Optionally, the locking portion is provided between both ends of the housing of the second electrical connector along the lengthwise direction.

Optionally, the opening of the receiving cavity faces outwards perpendicular to the lengthwise direction of the housing of the second electrical connector.

Optionally, a second cover is installed to the locking portion.

Optionally, the second cover has a substantially planar body portion in contact with the locking portion, a through hole is formed in the body portion and has an internal diameter which is sized such that the threaded portion of the locking member can freely pass the through hole but prevent the retaining member from passing the body portion.

Optionally, the second cover comprises two flanks extending from two edges of the body portion substantially perpendicular to the body portion.

Optionally, a mounting portion extends from a free end of each flank to be exposed on the first side of the housing of the second electrical connector and thus be attached onto the additional PCB.

Some embodiments relate to an electronic system. The electrical connector may include a plug electrical connector connected with a first PCB at one side; a receptacle electrical connector connected with a second PCB at one side, the plug electrical connector connected to the receptacle electrical connector; and a locking structure according to any one of claims 62 to 98 at an end of the plug and receptacle electrical connectors along a lengthwise direction, to lock the plug electrical connector, the first PCB and the receptacle electrical connector together or lock the receptacle electrical connector, the second PCB and the plug electrical connector.

Optionally, the electronic system further comprises an additional locking structure according to any one of claims 62 to 98 provided at an opposite end of the plug and receptacle electrical connectors to lock the receptacle electrical connector, the second PCB and the plug electrical connector together or lock the receptacle electrical connector, the first PCB and the plug electrical connector together.

Some embodiments relate to an electrical connector. The electrical connector may include an insulative housing having a base portion and a tongue portion, the base portion having a first side and a second side opposing the first side along a heightwise direction of the housing, the tongue portion extending from the second side, the first side configured to be connected to a PCB; and a group of signal terminals provided in the housing and including a plurality of signal terminals spaced from each other along a lengthwise direction of the housing, the signal terminals partially projecting from and exposed from the tongue portion, wherein a plurality of signal terminal channels are defined in the housing to receive the plurality of signal terminals therein, wherein each signal terminal has an intermediate portion received in a corresponding one of the signal terminal channels, and a mounting portion bent relative to the intermediate portion and exposed at the first side of the base portion such that it can be attached to the PCB, wherein each signal terminal channel has a channel gap formed adjacent to the first side of the base portion such that a face of the respective intermediate portion departing away from the respective mounting portion is separated from the signal terminal channel.

Optionally, the electrical connector further comprises a group of power terminals provided in the housing.

Optionally, the group of power terminals comprises two power terminals which are at both ends of the group of signal terminals along the lengthwise direction of the housing.

Optionally, each power terminal comprises a substantially planar mounting portion and a clamping portion extending from an edge of the mounting portion.

Optionally, two power terminal channels are defined in the housing such that the two power terminals are installed in the two power terminal channels respectively.

Optionally, each power terminal channel is formed with opposing sidewalls to clamp the mounting portion of a respective power terminal therebetween.

Optionally, the clamping portion comprises four clamping portions which are spaced from each other in the widthwise direction of the housing and among which two clamping portions are on the outermost and two clamping portions are on the middle, wherein the two outermost clamping portions and the two middle clamping portions are respectively mirror-symmetrically curved relative to each other to define therebetween contact faces which are the closest to each other.

Optionally, the tongue portion is configured to receive a groove of another electrical connector or be received by the groove of said another electrical connector, complementary features are provided between the tongue portion and the groove such that the tongue portion can receive the groove of said another electrical connector or be received by the groove of said another electrical connector in a specific orientation only.

Optionally, the complementary features comprise a periphery contour of the tongue portion which is formed asymmetrically relative to a longitudinal central plane of the housing.

Optionally, the complementary features comprise a contact protrusion or a receiving recess formed in the tongue portion, and the contact protrusion or the receiving recess is provided asymmetrically relative to a longitudinal central plane of the housing.

Optionally, the electrical connector further comprises a first board holder and/or a second board holder to secure the housing of the electrical connector to the PCB.

Optionally, the first board holder has an insertion portion and a mounting portion extending from the insertion portion substantially at a right angle, wherein a board holder seat is formed in the housing, the insertion portion is configured to be inserted into a slot of the board holder seat such that the mounting portion is exposed at the first side and attached to the PCB.

Optionally, the second board holder has a substantially planar body portion, two insertion arms bent substantially perpendicularly from two sides of the body portion, and two mounting feet extending coplanar with the body portion, wherein two receiving holes are formed in the housing, the second board holder is configured such that after the two insertion arms are inserted into the two receiving holes, the two mounting feet are exposed at the first side and attached to the PCB.

Some embodiments relate to an electrical connector. The electrical connector may include an insulative housing having a first side and a second side opposing the first side along a heightwise direction of the housing, the first side configured to be connected to a PCB, a groove formed in the housing and opened at the second side; and a group of signal terminals provided in the housing and including a plurality of signal terminals spaced from each other along a lengthwise direction of the housing, the signal terminals partially exposed in the groove, wherein a plurality of signal terminal channels are defined in the housing to receive the plurality of signal terminals therein, wherein each signal terminal has an intermediate portion, and a mounting portion and a tip which are located at opposing ends of the intermediate portion, the mounting portion is bent relative to the intermediate portion, and each signal terminal is provided in a corresponding signal terminal channel such that the mounting portion is exposed on the first side of the housing and the tip is adjacent to the second side of the housing, wherein each signal terminal channel has a first channel gap formed adjacent to the first side of the housing, through which first channel gap, a face of the tip facing outwards in the signal terminal channel is separated from a wall of the signal terminal channel.

Optionally, each signal terminal channel has a second channel gap formed in the second side of the housing, though which second channel gap, a face of the tip facing outwards in the signal terminal channel is separated from a wall of the signal terminal channel.

Optionally, the electrical connector further comprises a group of power terminals provided in the housing.

Optionally, the group of power terminals comprises two power terminals which are located at both ends of the group of signal terminals along the lengthwise direction of the housing.

Optionally, each power terminal is substantially planar, and comprises a mounting portion and an insertion portion extending from an edge of the mounting portion.

Optionally, two power terminal channels are defined in the housing to install the two power terminals respectively therein.

Optionally, each power terminal channel is in communication with the groove and is configured such that only the insertion portion of one power terminal is exposed in the groove when the power terminal is held in the power terminal channel.

Optionally, the groove is configured to receive a tongue portion of another electrical connector or be received by the tongue portion of said another electrical connector, complementary features are provided between the groove and the tongue portion such that the groove can receive the tongue portion of said another electrical connector or be received by the tongue portion of said another electrical connector in a specific orientation only.

Optionally, the complementary features comprise an inner contour of the groove which is formed asymmetrically relative to a longitudinal central plane of the housing.

Optionally, the complementary features comprise a receiving recess or a contact protrusion formed in the groove, which receiving recess or which contact protrusion is provided asymmetrically relative to a longitudinal central plane of the housing.

Optionally, the electrical connector further comprises a first board holder and/or a second board holder to secure the housing of the electrical connector to the PCB.

Optionally, the first board holder has an insertion portion and a mounting portion extending from the insertion portion substantially at a right angle, wherein a board holder seat is formed in the housing, the insertion portion is configured to be inserted into a slot of the board holder seat such that the mounting portion is exposed at the first side and attached to the PCB.

Optionally, the second board holder has a substantially planar body portion, two insertion arms bent substantially perpendicularly from two sides of the body portion, and two mounting feet extending coplanar with the body portion, wherein two receiving holes are formed in the housing, the second board holder is configured such that after the two insertion arms are inserted into the two receiving holes, the two mounting feet are exposed at the first side to be attached to the PCB.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electronic system, according to some embodiments;

FIG. 2 is another perspective view of the electronic system of FIG. 1;

FIG. 3 is a perspective view of a receptacle connector of the electronic system of FIG. 1;

FIG. 4 is another perspective view of the receptacle connector of FIG. 3;

FIG. 5 is a perspective view of a group of signal terminals of the receptacle connector of FIG. 3;

FIG. 6 is a side view of the group of signal terminals of FIG. 5;

FIG. 7 is a top view of the receptacle connector of FIG. 3;

FIG. 8 is an enlarged view of a region of the receptacle connector of FIG. 3 within a dashed box marked “B”in FIG. 7;

FIG. 9 is a cross-sectional view of the receptacle connector of FIG. 3 along a line marked “A-A”in FIG. 7;

FIG. 10 is the cross-sectional view of FIG. 9, with the signal terminals hidden;

FIG. 11 is a perspective view of a plug connector of the electronic system of FIG. 1;

FIG. 12 is another perspective view of the plug connector of FIG. 11;

FIG. 13 is a perspective view of a group of signal terminals of the plug connector of FIG. 11;

FIG. 14 is a side view of the group of signal terminals of FIG. 13;

FIG. 15 is a top view of the plug connector of FIG. 11;

FIG. 16 is an enlarged view of a region of the plug connector of FIG. 11 within a dashed box marked “BB”in FIG. 15;

FIG. 17 is a cross-sectional view of the plug connector of FIG. 11 along a line marked “C-C” in FIG. 15;

FIG. 18 is a cross-sectional view of FIG. 17, however, with the signal terminals hidden;

FIG. 19 is a bottom view of the plug connector of FIG. 11;

FIG. 20 is an enlarged view of a region of the plug connector of FIG. 11 within a dashed box marked “BBB”in FIG. 19;

FIG. 21 is a perspective view of the group of signal terminals and a group of power terminals of the receptacle connector of FIG. 3;

FIG. 22 is a side view of the group of signal terminals and the group of power terminals of FIG. 21;

FIG. 23 is a cross-sectional view of the receptacle connector of FIG. 3;

FIG. 24 is a perspective view of the group of signal terminals and a group of power terminals of the plug connector of FIG. 11;

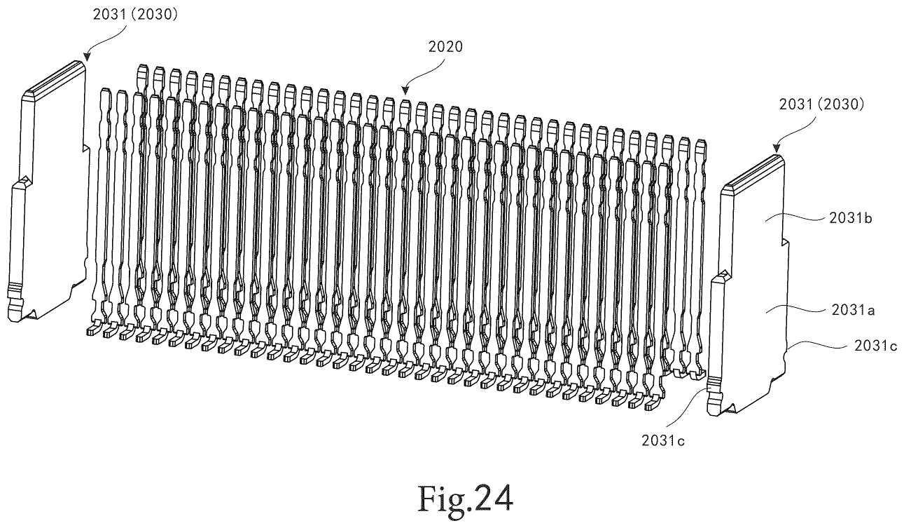

FIG. 25 is a side view of the group of signal terminals and the group of power terminals of FIG. 24;

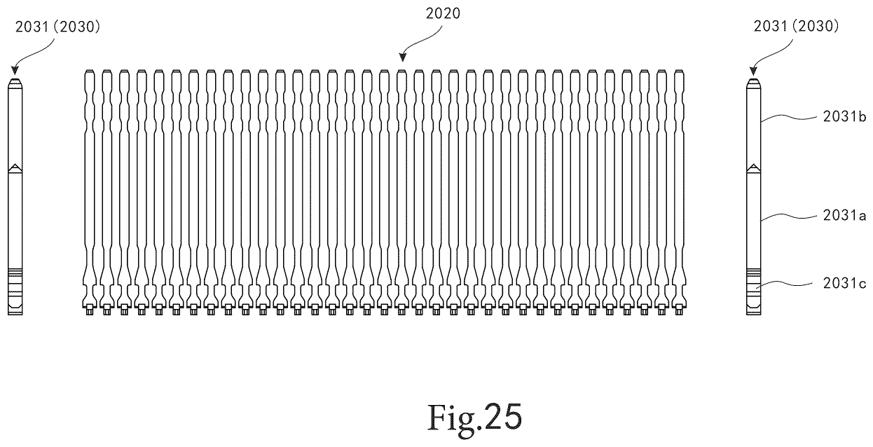

FIG. 26 is a cross-sectional view of the plug connector of FIG. 11;

FIG. 27 is a cross-sectional view of the electrical connector of FIG. 11;

FIG. 28 is a cross-sectional view of the electronic system of FIG. 1, with PCBs hidden and showing the electrical connectors of FIGS. 3 and 11;

FIG. 29 is a perspective view of the receptacle connector of FIG. 3, with a first board holder exploded from a housing;

FIG. 30 is a perspective view of the plug connector of FIG. 11, with a first board holder and a second board holder exploded from a housing;

FIG. 31 is a perspective view of a holding member of the receptacle connector of FIG. 3;

FIG. 32 is a perspective view of the electronic system of FIG. 1, showing the electrical connectors separated from each other and with a locking member exploded from the electrical connectors;

FIG. 33 is a perspective view of an electronic system, according to some embodiments;

FIG. 34 is a perspective view of the electronic system of FIG. 33, with housings and PCBs hidden;

FIG. 35 is a perspective view of an electronic system, according to some embodiments;

FIG. 36 is a perspective view of an electrical connector of the electronic system of FIG. 35;

FIG. 37 is a cross-sectional perspective view of the electrical connector of FIG. 36;

FIG. 38 is a cross-sectional perspective view of the electrical connector of FIG. 36, showing connected with a PCB and a locking member;

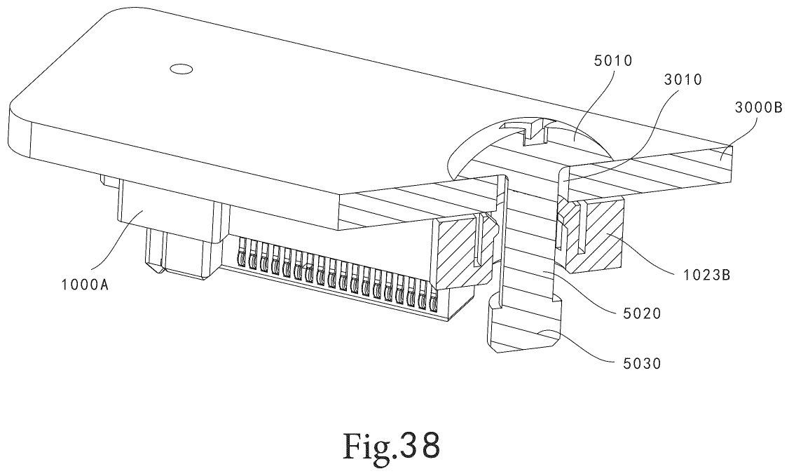

FIG. 39 is a cross-sectional perspective view of another electrical connector of the electronic system of FIG. 35;

FIG. 40 is a cross-sectional perspective view of the electronic system of FIG. 35;

FIG. 41 is a perspective view of an electronic system, according to some embodiments;

FIG. 42 is an exploded perspective view of the electronic system of FIG. 41;

FIG. 43 is a cross-sectional view of the electronic system of FIG. 41 along a line marked “F-F”′ in FIG. 41;

FIG. 44 is a partially exploded perspective view of an electrical connector of the electronic system of FIG. 41;

FIG. 45 is a partially exploded perspective view of another electrical connector of the electronic system of FIG. 41;

FIG. 46 is a cross-sectional view of an electronic system, according to some embodiments;

FIG. 47 is a perspective view of a plug electrical connector of the electronic system of FIG. 46, shown mounted on a PCB;

FIG. 48 is a top view of the plug connector as shown in FIG. 47;

FIG. 49 is an enlarged view of a portion of the plug connector of FIG. 47 within a circle marked “A”in FIG. 48;

FIG. 50 is a bottom view of the plug connector as shown in FIG. 47, with the PCB hidden;

FIG. 51 is an enlarged view of a portion of the plug connector as shown in FIG. 50 within a circle marked “B”in FIG. 50;

FIG. 52 is a perspective view of a receptacle connector of the electronic system of FIG. 46, shown mounted on a PCB;

FIG. 53 is a bottom view of the receptacle connector as shown in FIG. 52, with the PCB hidden;

FIG. 54 is an enlarged view of a portion of the receptacle connector as shown in FIG. 53 within a circle marked “C”in FIG. 53;

FIG. 55 is a perspective view of a plug connector, according to some embodiments; and

FIG. 56 is a perspective view of a receptacle connector configured to mate with the plug connector of FIG. 55, according to some embodiments.

### DETAILED DESCRIPTION

The inventors have recognized and appreciated design techniques for electrical connectors to provide power and/or high-speed signal connections with a compact form factor. Conventional approaches typically employ separate power and signal connectors, or bulky hybrid designs that increase the connector height or width to accommodate mechanical fastening or high-current contact structures. Such configurations complicate board layouts, increase impedance discontinuities, and add manufacturing cost. The techniques described herein may lead to compact yet robust connectors to provide power and/or high-speed signal connections, with reduced crosstalk and insertion loss, thereby improved signal integrity and reliability.

According to aspects of the present disclosure, an electrical connector may include a housing with an elongated portion supporting a row of closely spaced signal terminals. Power terminals may be disposed on opposite sides of the signal terminals and extend generally perpendicular to the signal-terminal row. Each power terminal can include a blade-shaped mounting portion for secure attachment to a circuit board and a mating portion configured for clamping engagement with a corresponding power terminal of a mating connector. This configuration segregates power and signal paths for improved electrical performance, while maintaining a low-profile cross section.

In some embodiments for a header connector, the elongated portion of the housing may include first and second walls separated by an elongated slot, with channels on one wall for receiving blade-shaped signal terminals. Each channel can define a gap between the signal terminal and the housing wall to maintain impedance control and facilitate molding tolerances.

In some embodiments for a receptacle connector, the connector may employ a tongue-and-beam configuration. The housing may include a base and a tongue portion protrudes from the base. Beam-shaped signal terminals may be arranged on opposite sides of the tongue.

In some embodiments, the housing may include first and second end portions, each having a slot for receiving a respective power terminal. In some embodiments, the end portions may be asymmetrically shaped relative to a longitudinal center plane of the housing, allowing improved mating alignment.

In some embodiments, the housing may include one or more locking portions configured to receive one or more locking members. The locking portions may be located along the elongated portion or at its ends, which may depend on board layout requirements. In some embodiments, the locking member may include a head, a threaded portion, and a connecting portion between the head and the threaded portion. The threaded portion may have a diameter greater than that of the connecting portion.

In some embodiments, a locking portion may include a through-hole containing a locking feature, such as a conductive or insulative beam, configured to restrain movements of a locking member inserted through the hole. This integrated locking design may enhance coupling strength between mating connectors or between a connector and a board, without relying on external brackets or oversized housings.

In some embodiments, holding or retaining members (e.g., nuts, covers, or other retaining features) may be disposed in the locking portions to secure the locking members and prevent loosening under vibration or thermal stress. In some embodiments, the retaining member may include a cover extending along the mating face of the housing, with mounting feet configured for attachment to a circuit board for additional stability.

The techniques described herein may enable hybrid electrical connectors to deliver both high-speed signal integrity and high-current capacity in a single compact assembly. The integration of closely spaced signal rows, perpendicular power terminals, and embedded locking structures may enable secure mechanical engagement, electrical isolation, and manufacturability suitable for board-to-board interconnect applications.

In the present disclosure, the description to embodiments and technical solutions relevant to “a plug type of electrical connector (or a plug electrical connector)” or “a male connector (or a male electrical connector)” are also applicable to embodiments and technical solutions relevant to “a receptacle type of electrical connector (or a receptacle electrical connector)” or “a female connector (or a female electrical connector).” It should be understood by a person skilled in the art that a feature or some features in the technical solutions of “a plug type of electrical connector (or a plug electrical connector)” or “a male connector (or a male electrical connector)” can be alternatively adopted in the technical solutions of “a receptacle type of electrical connector (or a receptacle electrical connector)” or “a female connector (or a female electrical connector),”and vice versa.

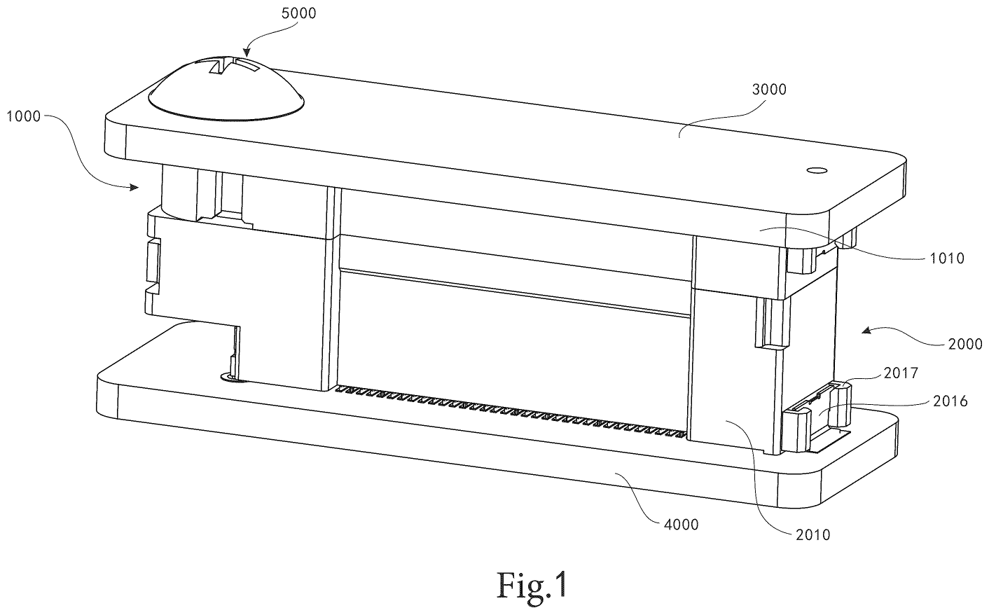

As shown in FIG. 1, an electronic system may comprise a receptacle type of electrical connector 1000 and a plug type of electrical connector 2000 mated with each other, a PCB 3000 connected to the plug type of electrical connector 1000, a PCB 4000 connected to the receptacle type of electrical connector 2000, and a locking member 5000 configured to lock the plug type of electrical connector 2000 and the PCB 3000 together.

It should be appreciated that in the embodiments as explained below or their modifications, the locking member 5000 and a feature mating therewith can be optionally adopted in the electronic system or a respective electrical connector. Therefore, the technical solutions as explained in the embodiments or modifications as explained herein (like the electronic system and/or the electrical connector) can include or not include the locking member and the feature mating therewith.

The plug type of electrical connector (or the plug electrical connector) 1000 comprises an insulative housing (or a housing or a plastic body) 1010. In some embodiments, the housing 1010 can be integrally made of an insulative material or can be assembled by several insulative parts (for example parts including an electrically lossy material). Along a lengthwise direction of the housing 1010, a group of signal terminals 1020 is arranged in the housing 1010 such that it is partially exposed therein.

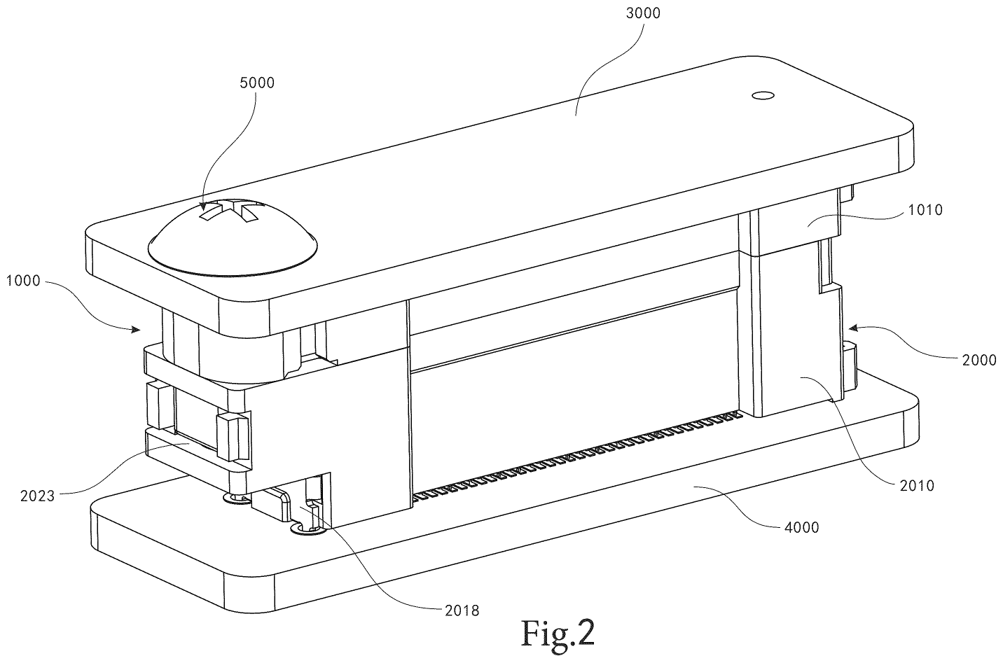

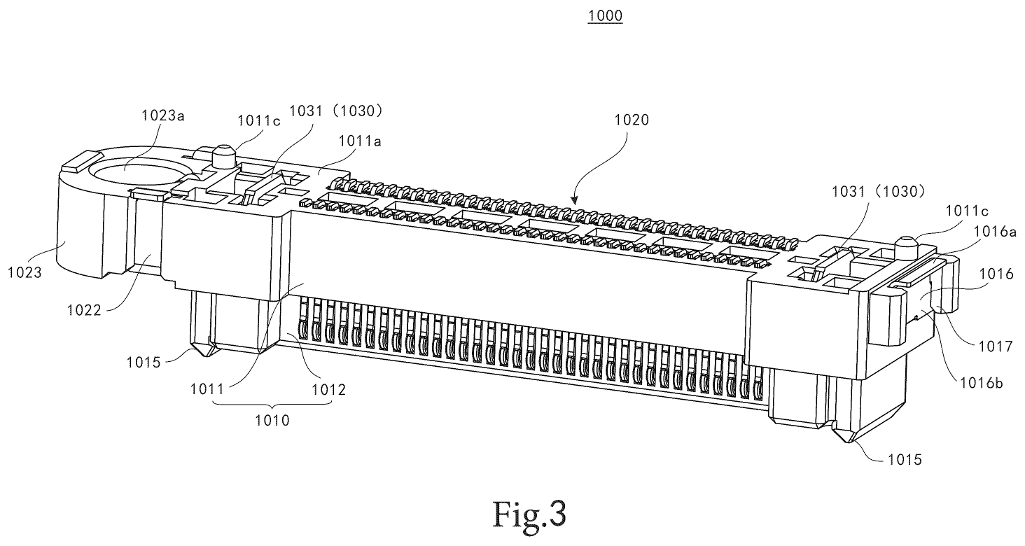

As shown by FIG. 3, the housing 1010 generally comprises a base portion 1011 and a tongue portion 1012. The base portion 1011 comprises a first side 1011a configured to contact the PCB 3000 (as shown by FIGS. 1 and 2) and a second side 1011b opposing the first side 1011a along a heightwise direction of the housing 1010. The tongue portion 1012 extends from the second side 1011b of the base portion 1011, and is configured to receive or be inserted into at least a portion of the plug electrical connector 2000. An alignment protrusion 1011c (for example, two alignment protrusions 1011c shown) is provided in the first side 1011a such that the alignment protrusion can protrude therefrom, and is configured to be inserted into a respective alignment hole (not shown) of the PCB 3000 when the PCB 3000 is connected to the receptacle electrical connector 1000, achieving an alignment function.

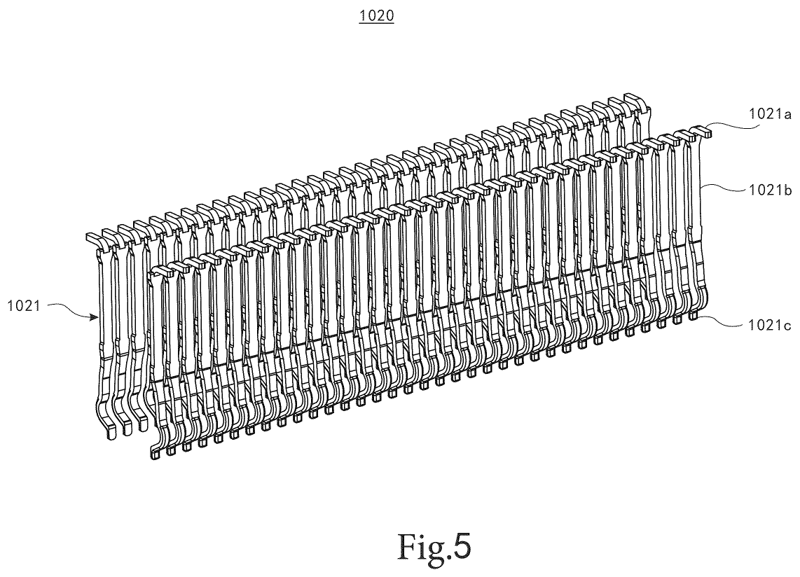

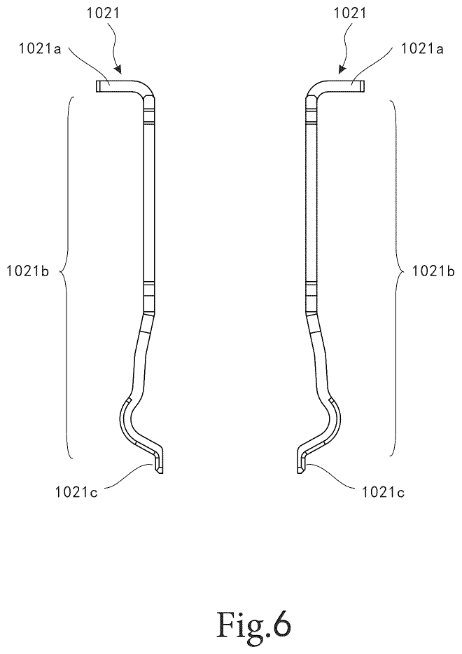

As shown by FIG. 5, the group of signal terminals 1020 comprises at least two rows of signal terminals 1021 which are arranged along the lengthwise direction of the housing 1010 such that they are spaced from each other respectively. For example, each signal terminal 1021 can be formed by an elongated conductive metal sheet. It should be understood that the signal terminals 1021 comprise terminals specially designed for grounding and terminals specially designed for transmitting electrical signals. Further as shown by FIG. 6, the signal terminals 1021 in the two rows are formed respectively such that they mirror each other symmetrically. Each signal terminal 1021 comprises a mounting portion 1021a, an intermediate portion 1021b, and a tip 1021c. The mounting portion 1021a at an end of the intermediate portion 1021b is bent, for example bent substantially at a right angle, relative to a body of the intermediate portion 1021b. The tip 1021c is disposed at a longitudinally opposing end of the intermediate portion 1021b.

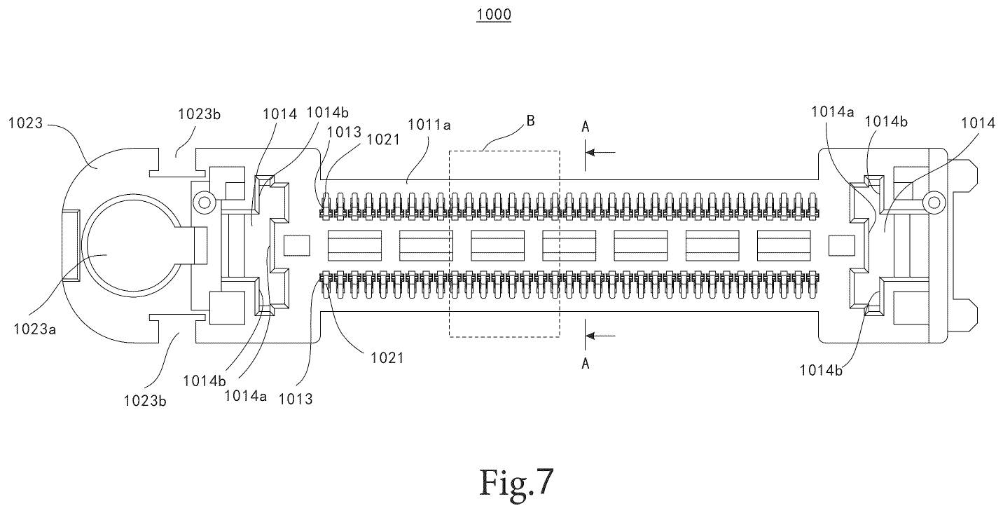

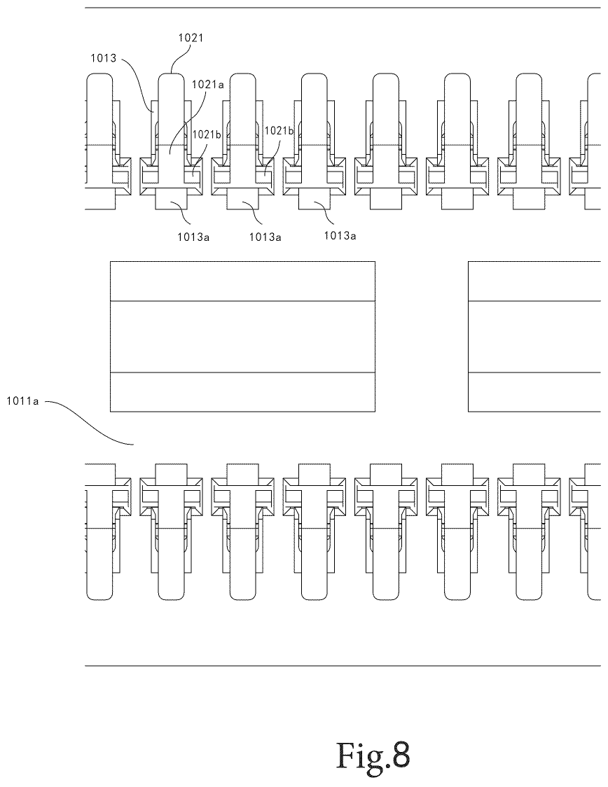

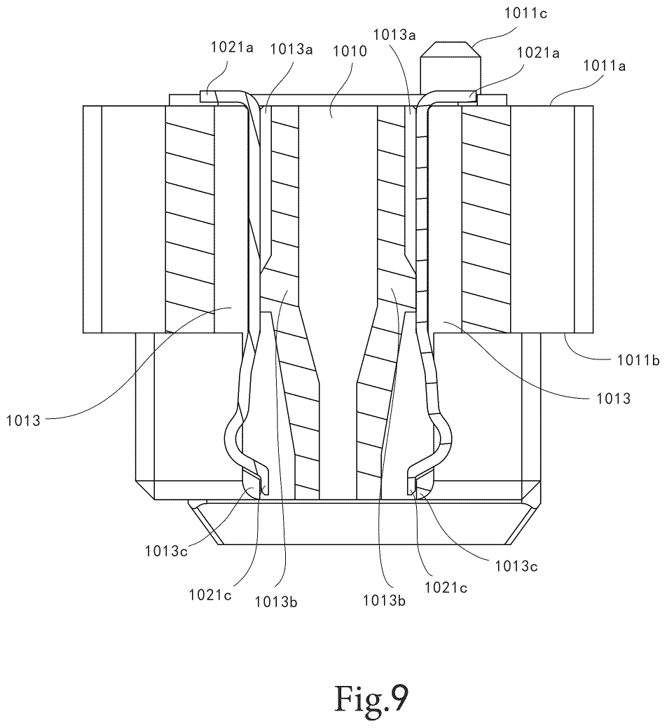

As shown by FIGS. 7 and 8, signal terminal channels 1013 are defined in the housing 1010 and the number of the signal terminal channels 1013 corresponds to the signal terminals 1021. For example, as shown, two rows of signal terminal channels 1013 are provided in the housing 1010 such that the two rows are spaced from each other along a widthwise direction of the housing 1010. Each row of signal terminal channels 1013 comprises a plurality of signal terminal channels 1013 spaced from each other along the lengthwise direction of the housing 1010. As shown by FIG. 9, each signal terminal channel 1013 is configured to receive a corresponding signal terminal 1021 substantially in the heightwise direction of the housing 1010 such that the mounting portion 1021a of this signal terminal 1021 is exposed on the first side 1011a of the housing 1010 and the tip 1021c of this signal terminal 1021 is caught by a tip 1013c of the signal terminal channel 1013. In some embodiments, the tip 1013c of the signal terminal channel 1013 is formed in the tongue portion 1012. As shown, the intermediate portion 1021b of each signal terminal 1021 is formed with several widened parts in its widthwise direction. In this way, contacting and mating of the widened parts of a signal terminal 1021 with a sidewall of a respective signal terminal channel 1013 enables the signal terminal to be reliably secured in the signal terminal channel 1013. When the signal terminals 1021 are secured in the housing 1010 in place, the mounting portions 1021a of the signal terminals 1021 are exposed on the first side 1011a of the housing 1010 and can be configured to be attached onto the PCB 3000 using surface mount technology (SMT) or reflow soldering technology.

As shown by FIG. 9, when a signal terminal 1021 are secured in the housing 1010 in place, a part of the intermediate portion 1021b of the signal terminal 1021 protrudes outwards from the tongue portion 1012 (or in other words it extends from the tongue portion 1012 towards Attorney a side of the housing 1010) to enable the part to come into contact with a corresponding signal terminal (as explained below) of the plug electrical connector 2000 when the receptacle electrical connector 1000 receives the plug electrical connector 2000.

A contact protrusion 1013b is formed in a wall of each signal terminal channel 1013 to contact the intermediate portion 1021b of a signal terminal 1021 received in the signal terminal channel 1013 and to cooperate with the tip 1021c of the signal terminal to exert opposite forces onto the signal terminal 1021. In some embodiments, the contact protrusion 1013b is configured to contact a face of the signal terminal 1021 within the signal terminal channel 1013, which face departs from the bending of the mounting portion 1021a of the signal terminal 1021. Therefore, in each signal terminal channel 1013, a channel gap 1013a is formed from the respective mounting portion 1021a or the first side 1011a of the housing 1010 to a position where the respective contact protrusion 1013b locates. The channel gap 1013a is adjacent to the face of a respective signal terminal 1021 departing from the bending of the mounting portion 1021a when the signal terminal 1021 is securely installed in the signal terminal channel 1013. Therefore, a face of the intermediate portion 1021b departing from the mounting portion 1021a is separated from a respective wall of the signal terminal channel 1013. The existence of the channel gaps 1013a results in a decreased contact area between the signal terminals 1021 and the housing 1010, to correspondingly reduce dielectric constant and improve the ability of the electrical connector 1000 to transmit high-frequency signals, thus achieving high-speed signal transmission.

In some embodiments, the channel gap 1013a can be configured to have a width which is slightly less than (as shown), equal to or greater than a width of a respective signal terminal 1021 or the intermediate portion 1021b thereof. The channel gap 1013a has a length which depends on a distance between the first side 1011a of the housing 1010 and the contact protrusion 1013b.

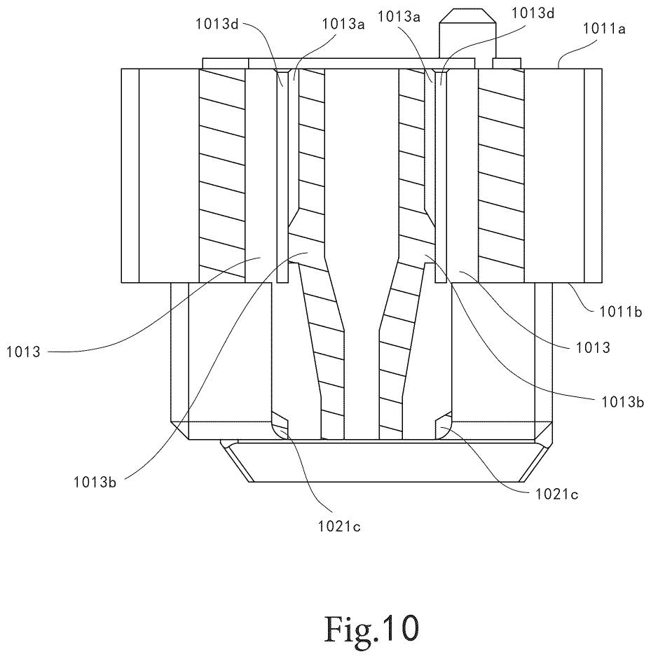

Further as shown by FIG. 10, the signal terminal channels 1013 in the two rows are defined in the housing 1010 such that the signal terminal channels mirror each other symmetrically. In each signal terminal channel 1013, a widened channel section 1013d is formed between the first side 1011a and the second side 1011b substantially along the heightwise direction of the housing 1010, and the channel gap 1013a is between the widened channel section 1013d and a wall of the signal terminal channel 1013 along the widthwise direction of the housing 1010, from which wall of the signal terminal channel 1013 the contact protrusion 1013b extends. The widened channel section 1013d is configured to receive a widened part (not shown) of the intermediate portion 1021b.

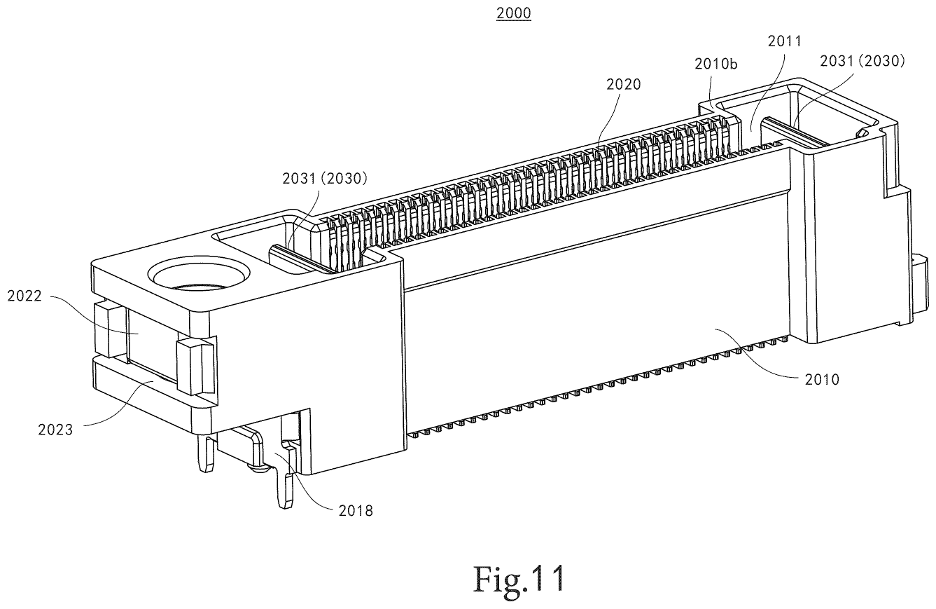

As shown by FIG. 11, the plug electrical connector 2000 comprises an insulative housing (or called as a housing or a plastic body) 2010. In some embodiments, the housing 2010 can be integrally made of an insulative material or assembled by several insulative parts (for example parts including an electrically lossy material). Along a lengthwise direction of the housing 2010, a group of signal terminals 2020 is arranged in the housing 2010 such that it is partially exposed therein.

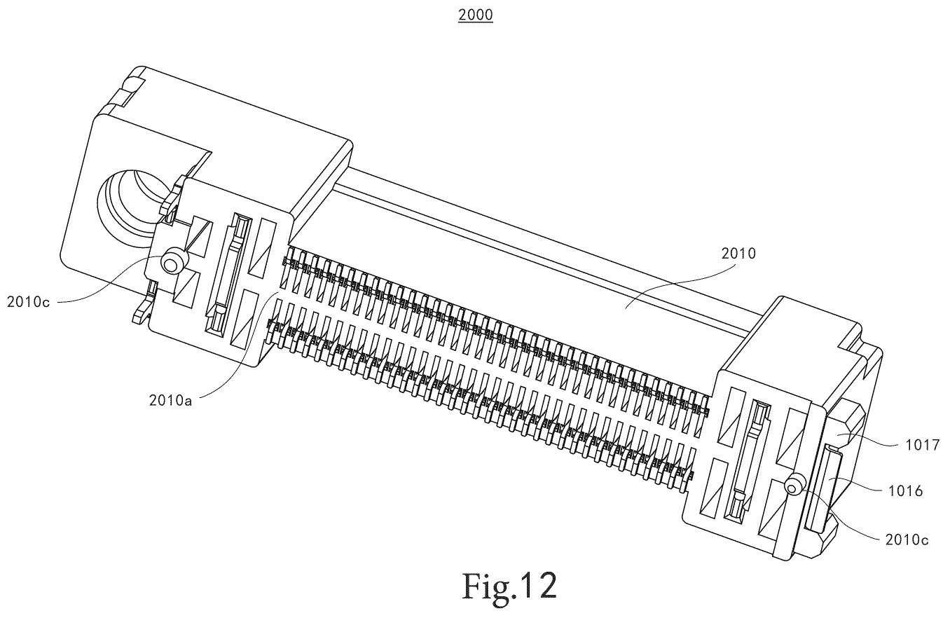

As shown by FIGS. 11 and 12, the housing 2010 of the plug electrical connector 2000 has a first side 2010a configured to contact the PCB 4000 (as shown by FIGS. 1 and 2) and a second side 2010b opposing the first side 2010a along a heightwise direction of the housing 2010. An alignment protrusion 2010c (for example, two alignment protrusions 2010c shown) is provided in the first side 2010a such that the alignment protrusion can protrude therefrom, and is configured to be inserted into a respective alignment hole (not shown) of the PCB 4000 when the PCB 4000 is connected to the plug electrical connector 2000, achieving an alignment function.

The housing 2010 of the plug electrical connector 2000 is defined with a groove 2011 recessed from the second side 2010b of the housing. The groove 2011 is configured to accommodate the tongue portion 1012 of the receptacle electrical connector 1000 when the plug electrical connector 2000 is connected to the receptacle electrical connector 1000. For example, the housing 2010 of the plug electrical connector 2000 and the housing 1010 of the receptacle electrical connector 1000 are configured such that when the plug electrical connector 2000 is connected to the receptacle electrical connector 1000 in place, the second side 2010b of the housing 2010 faces or comes into contact with the second side 1010b of the housing 1010.

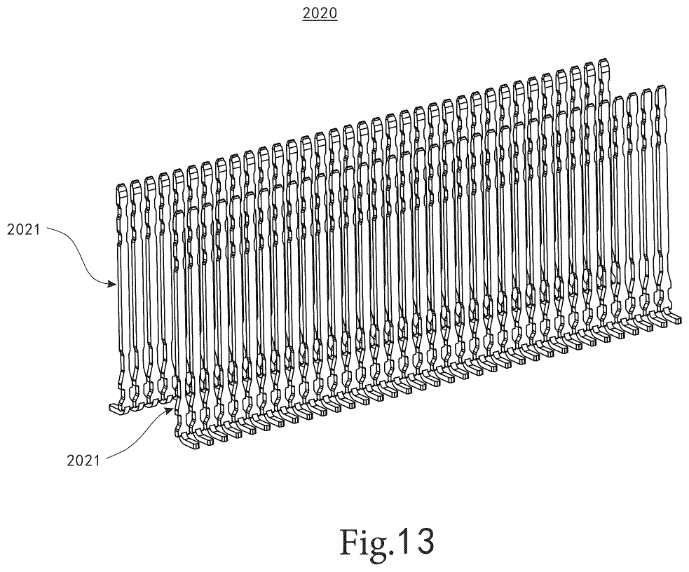

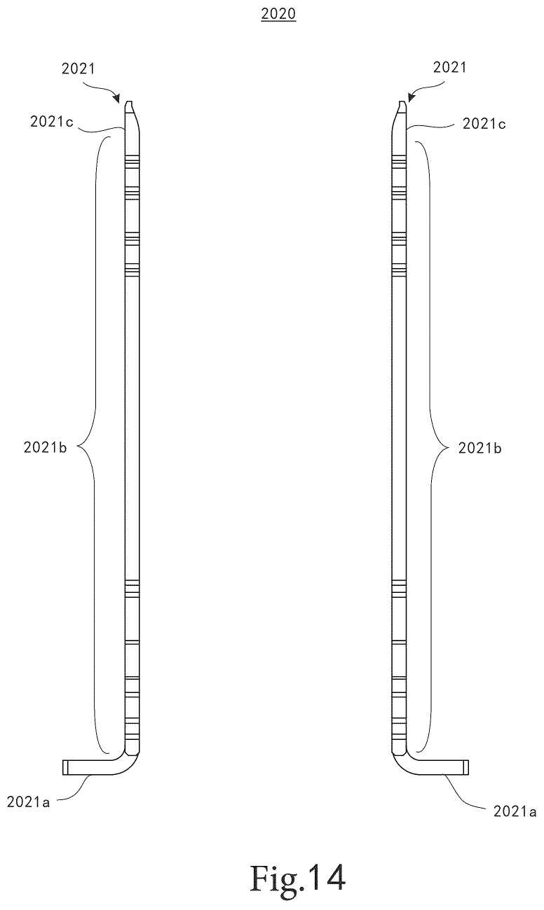

As shown by FIG. 13, the group of signal terminals 2020 comprises at least two rows of electrical terminals 2021 which are arranged along the lengthwise direction of the housing 2010 such that they are spaced from each other respectively. For example, each signal terminal 2021 can be formed by an elongated conductive metal sheet. It should be understood that the signal terminals 2021 comprise terminals specially designed for grounding and terminals specially designed for transmitting electrical signals. Further as shown by FIG. 14, the signal terminals 2021 in the two rows are formed respectively such that they mirror each other symmetrically. Each signal terminal 2021 comprises a mounting portion 2021a, an intermediate portion 2021b, and a tip 2021c. The mounting portion 2021a at an end of the intermediate portion 2021b is bent, for example bent substantially at a right angle, relative to the intermediate portion 2021b. The tip 2021c is disposed at a longitudinally opposing end of the intermediate portion 2021b.

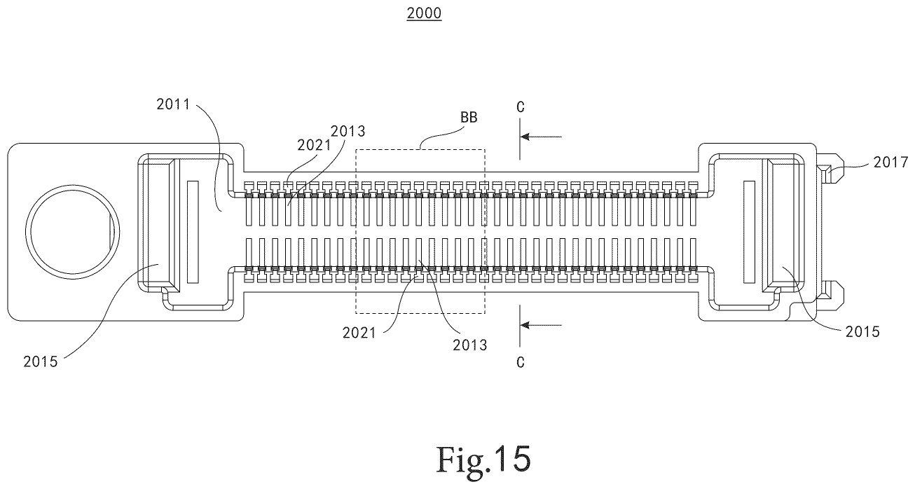

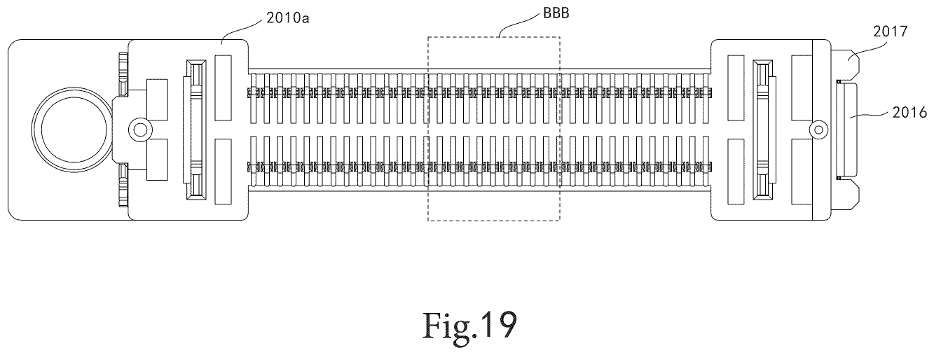

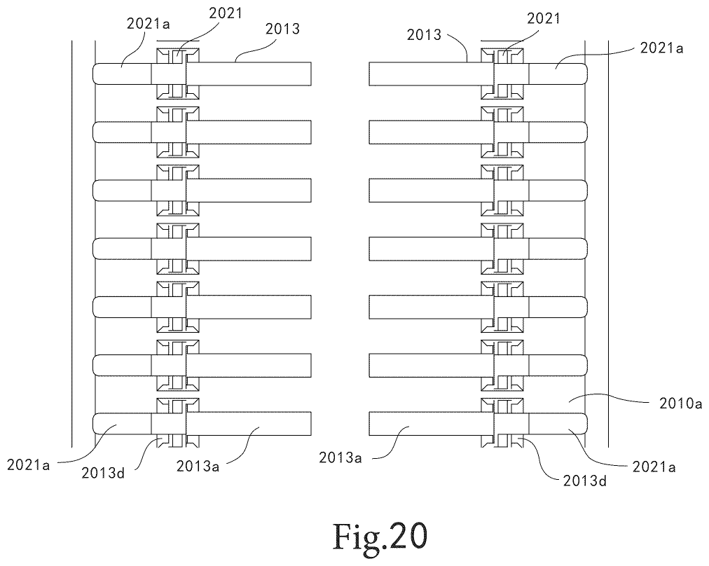

As shown by FIGS. 15, 16, 19 and 20, signal terminal channels 2013 are defined in the housing 2010 and the number of the signal terminal channels 2013 corresponds to the signal terminals 2021. For example, as shown, two rows of signal terminal channels 2013 are provided in the housing 2010 such that the two rows are spaced from each other along a widthwise direction of the housing 2010. Each row of signal terminal channels 2013 comprises a plurality of signal terminal channels 2013 spaced from each other along the lengthwise direction of the housing 2010. When the plug electrical connector 2000 is connected to the receptacle electrical connector 1000 in place, the respective signal terminal channels 1013 and 2013 align with each other such that the corresponding signal terminals 1021 and 2021 received therein come into conductive contact with each other respectively. For example, when the signal terminals 2021 are secured in the housing 2010 in place, the tips 2021c and the intermediate portions 2021b of the signal terminals 2021 can be partially exposed in the groove 2011, for instance exposed at two opposite inner walls of the groove 2011. When the tongue portion 1012 is contained within the groove 2011, the signal terminals 2021 can come into conductive contact with the signal terminals 1021 respectively. When the signal terminals 2021 are secured in the housing 2010 in place, the mounting portions 2021a of the signal terminals 2021 are exposed on the first side 2010a of the housing 2010 and are configured to be attached onto the PCB 400 using surface mount technology or reflow soldering technology.

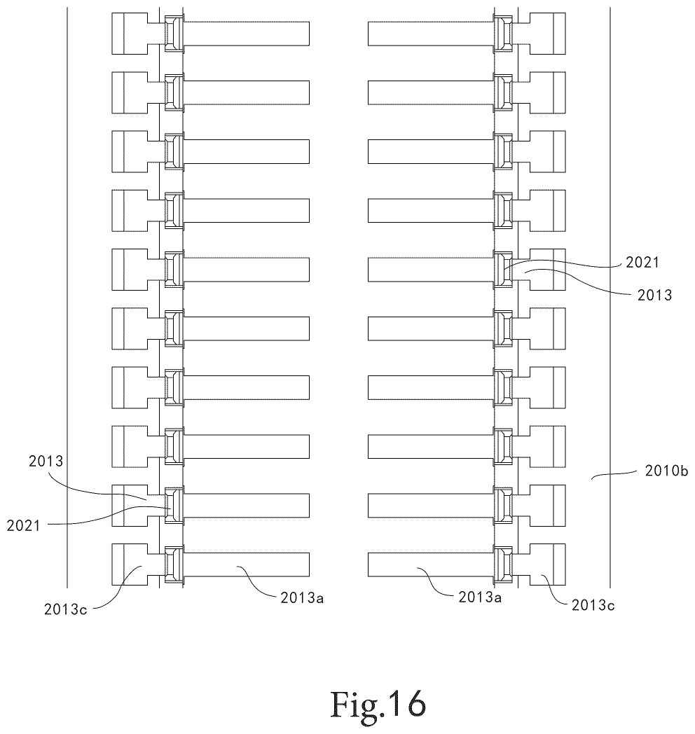

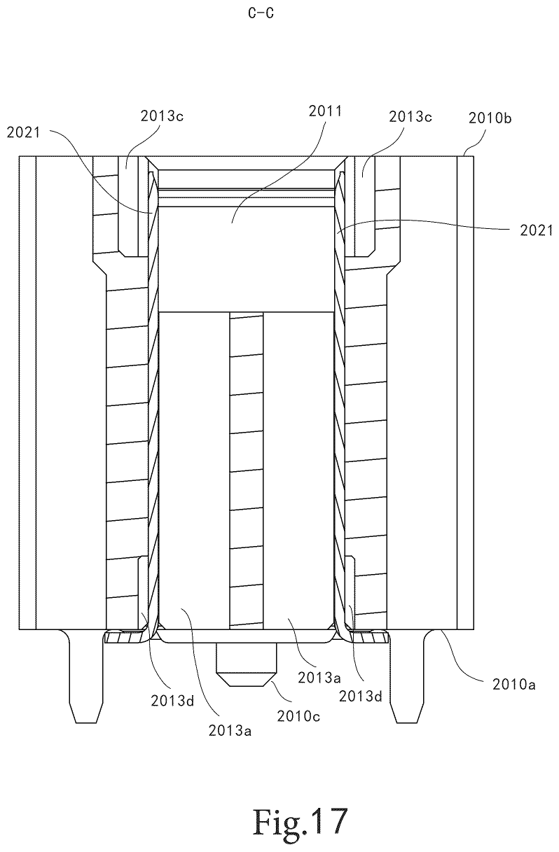

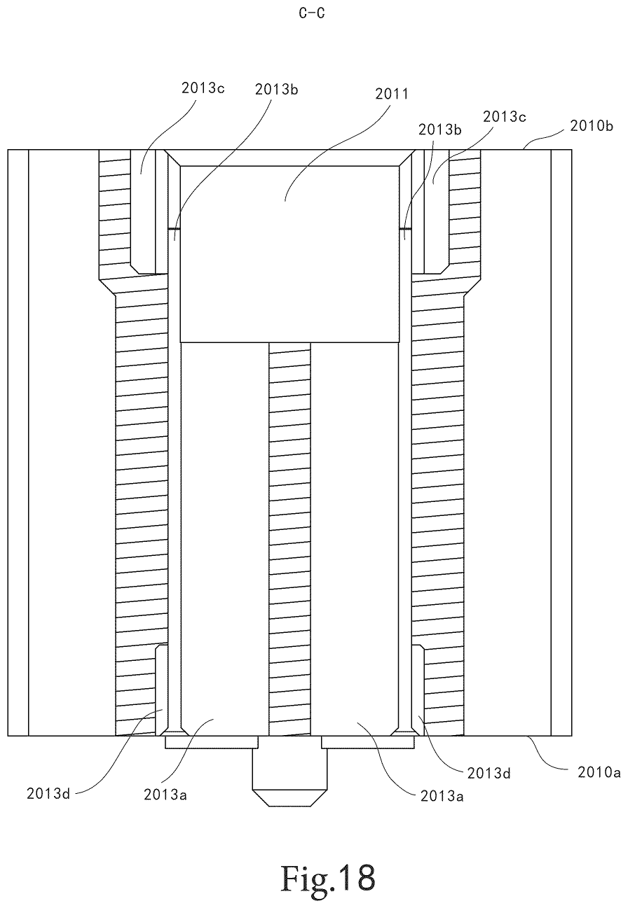

As shown by FIGS. 17 and 18, each signal terminal channel 2013 is configured to extend between the first side 2010a and the second side 2010b substantially along the heightwise direction of the housing 2010 to receive a corresponding signal terminal 2021. In some embodiments, the signal terminal channels 2013 can be configured to be in communication with the groove 2011. For example, as shown by FIGS. 16 to 20, the signal terminal channels 2013 in the two rows are defined in the housing 2010 such that they are mirror-symmetrical relative to a longitudinal central axis of the housing 2010. Each signal terminal channel 2013 has a channel slot 2013a adjacent to the longitudinal central axis of the housing 2010. For example, the channel slot 2013a extends between the groove 2011 and the first side 2010a along the heightwise direction of the housing 2010. For example, the channel slot 2013a has a width (for instance a width measured in a direction substantially perpendicular to the plane of FIG. 18) which is less than a width of the intermediate portion 2021b of the respective signal terminal 2021. As shown by FIG. 18, each signal terminal channel 2013 further comprises a widened channel section 2013b. A width of the widened channel section 2013b (for instance a width measured in the direction substantially perpendicular to the plane of FIG. 18) is sized such that the widen channel section can be used to receive the intermediate portion 2021b of a respective signal terminal 2021, especially several widened parts (not shown) formed on the intermediate portion. In this way, the intermediate portion 2021b can be securely clamped in the widened channel section 2013b. Moreover, the width of the channel slot 2013a is less than the width of the channel section 2013b such that after a signal terminal 2021 is placed in a respective signal terminal channel 2013, a part of the housing at both sides of the channel slot 2013a can abut against at least a part of the intermediate portion 2021b of the signal terminal 2021.

In some embodiments, in each signal terminal channel 2013, a channel gap 2013c and a channel gap 2013d are formed adjacent to the second side 2010b and the first side 2010a respectively. Through the channel gap 2013d, a face of the intermediate portion 2021b facing outwards in the signal terminal channel 2013 (for instance, in case of a left signal terminal of FIG. 17, a face of the signal terminal's intermediate portion facing leftwards; in case of a right signal terminal of FIG. 17, a face of the signal terminal's intermediate portion facing rightwards) is separated from a wall of the signal terminal channel 2013; through the channel gap 2013c, a face of the tip 2021c facing outwards in the signal terminal channel 2013 is separated from a wall of the signal terminal channel 2013. For example, viewed in the widthwise direction of the housing 2010, the widened channel section 2013b of each signal terminal channel 2013 is located between the channel slot 2013a and the channel gaps 2013c, 2013d. In some embodiments, each of the channel gaps 2013c, 2013d has a width (for example, a width measured in a direction substantially perpendicular to the plane of FIG. 18) which is less than the width of the channel section 2013b. In some embodiments, in the heightwise direction of the housing 2010, the channel gaps 2013c, 2013d of each signal terminal channel 2013 are configured to be not in communication with each other to ensure that the housing always has a part to contact a face of the intermediate portion 2021b of the signal terminal 2021, towards which face the mounting portion 2021a of the signal terminal is bent. The existence of the channel gaps 2013c, 2013d results in a decreased contact area between the signal terminals 2021 and the housing 2010, to correspondingly reduce dielectric constant and improve the ability of the electrical connector 2000 to transmit high-frequency signals, thus achieving high-speed signal transmission.

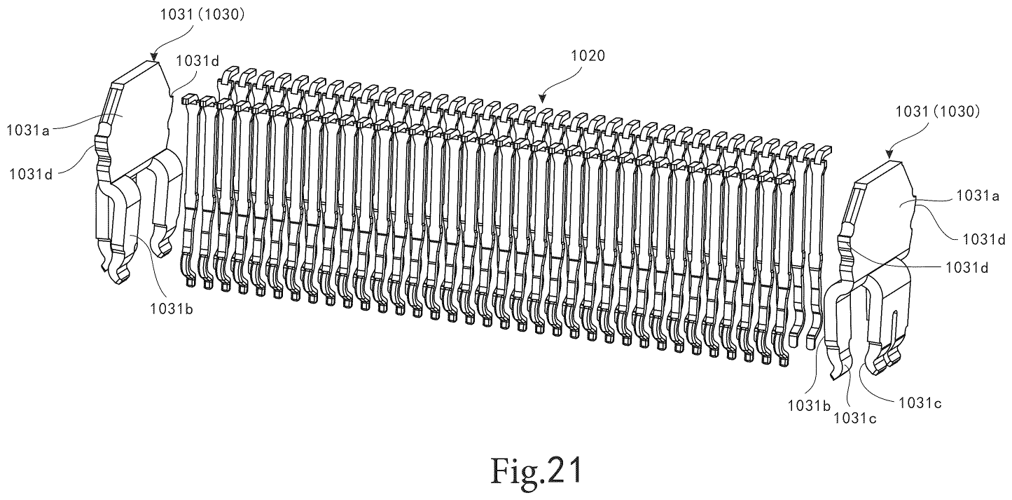

As shown by FIG. 3, in some embodiments, in addition to the group of signal terminals 1020, the electrical connector 1000 also comprises a group of power terminals 1030. The group of power terminals 1030 is configured to transmit large electrical currents or implement power transmission. For example, the group of power terminals 1030 comprises two power terminals 1031. As shown by FIG. 21, when installed in the housing 1010 of the electrical connector 1000, the two power terminals 1031 are located respectively at or adjacent to both ends of the signal terminals 1020 along the lengthwise direction of the housing 1010. As shown, the two power terminals 1031 are arranged in the housing 1010 such that they are mirror-symmetrical to each other. Each power terminal 1031 is formed by a conductive metal sheet, for example via stamping.

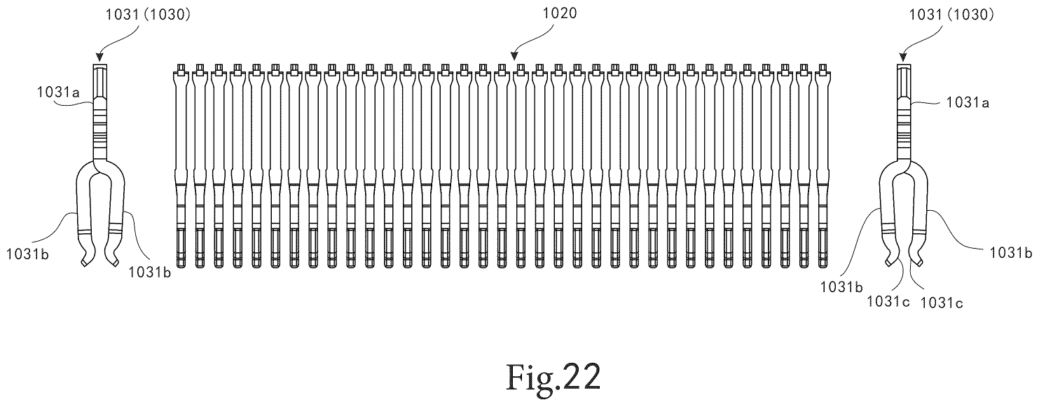

Each power terminal 1031 comprises a mounting portion 1031a and a clamping portion 1031b extending from an edge of the mounting portion 1031a. For instance, in some embodiments, the clamping portion 1031b comprises four clamping portions 1031b which are spaced from each other along the widthwise direction of the housing 1010. Among the clamping portions, two clamping portions 1031b are on the outermost and two clamping portions 1031b are on the middle. The mounting portion 1031a is substantially planar, and the outermost two clamping portions 1031b and the middle two clamping portions 1031b are formed such that the outermost two are mirror-symmetrical to the middle two (as shown by FIG. 22) and thus two oppositely curved clamping portions 1031b have contact faces 1031c which are the closest to each other. A distance measured between the two contact faces 1031c along the lengthwise direction of the housing 1010 is a thickness of an insertion part (as explained below) of a power terminal of the electrical connector 2000 such that when the insertion part of the power terminal of the electrical connector 2000 is inserted between the two oppositely curved clamping portions 1031b, the clamping portions 1031b will deform to exert a clamping force on the power terminal of the electrical connector 2000.

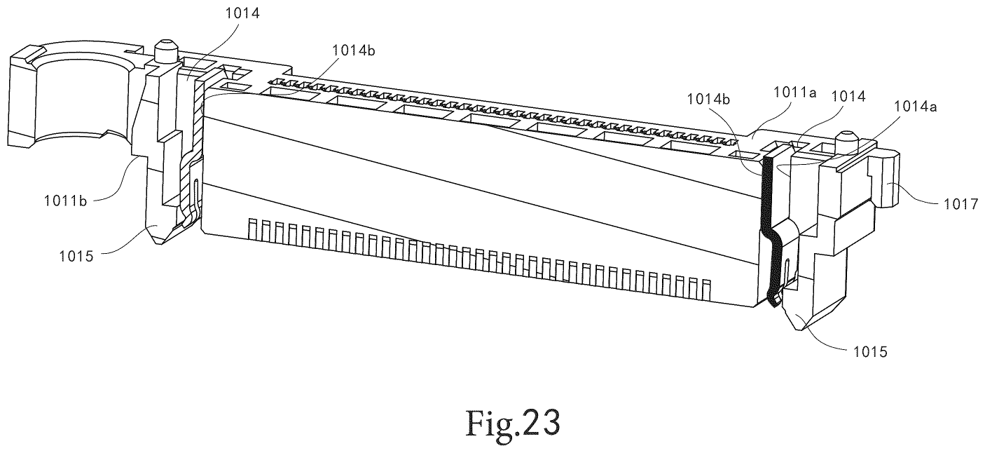

In order to receive the power terminal 1031, a power terminal channel 1014 is formed in the housing 1010 of the electrical connector 1000. For example, as shown by FIG. 23, two power terminal channels 1014 are provided respectively at or adjacent to both ends of the signal terminal channels 1013 along the lengthwise direction of the housing 1010. The power terminal channels 1014 are formed to extend through both of the base portion 1011 and the tongue portion 1012 of the housing 1010 along the heightwise direction of the housing 1010. At least in the base portion 1011, each power terminal channel 1014 is formed with two opposing sidewalls 1014a and 1014b such that when a respective power terminal 1031 is received in the power terminal channel 1014 in place, the sidewalls 1014a and 1014b can abut against opposing flanks of the mounting portion 1031a of the power terminal 1031.

The mounting portion 1031a of a power terminal 1031 is formed with two bumps 1031d which are spaced from each other along a widthwise direction of the mounting portion, such that when the power terminal 1031 is installed in a respective power terminal channel 1014, the bumps 1031d will be snapped in a channel section between the sidewalls 1014a and 1014b to secure the power terminal 1031 in the power terminal channel 1014 in place. When the power terminal has been secured in place, the mounting portion 1031a of the power terminal 1031 is in the base portion 1011 and an edge of the mounting portion 1031a of the power terminal 1031 opposing the clamping portions 1031b is exposed at the first side 1011a of the housing 1010, and can be configured to be attached onto the PCB 3000 using surface mount technology or reflow soldering technology. Furthermore, when the power terminal 1031 is secured in the power terminal channel 1014 in place, the clamping portions 1031b of the power terminal 1031 are located in the tongue portion 1012 and are in an unstressed state in the power terminal channel 1014, as shown by FIG. 23.

As shown by FIG. 11, in some embodiments, in addition to the group of signal terminals 2020, the electrical connector 2000 also comprises a group of power terminals 2030. The group of power terminals 2030 is configured to transmit large electrical currents or implement power transmission. For example, the group of power terminals 2030 comprises two power terminals 2031. As shown by FIG. 11 24 and 45, when installed in the housing 2010 of the electrical connector 2000, the two power terminals 2031 are located respectively at or adjacent to both ends of the signal terminals 2020 along the lengthwise direction of the housing 2010. As shown, the two power terminals 2031 are arranged in the housing 2010 such that they are mirror-symmetrical to each other. Each power terminal 2031 is formed by a conductive metal sheet, for example via stamping.

Each power terminal 2031 is generally planar, and comprises a mounting portion 2031a and an insertion portion 2031b extending from an edge of the mounting portion 2031a. The insertion portion 2031a is configured such that when the groove 2011 of the electrical connector 2000 has received the tongue portion 1012 of the electrical connector 1000, the insertion portion is inserted between the contact faces 1031c of the respective power terminals 1031 of the electrical connector 1000 and can be clamped by the oppositely curved clamping portions 1031b to come into conductive contact with them. In some embodiments, the insertion portion 2031b has a width which is less than a width of the mounting portion 2031a.

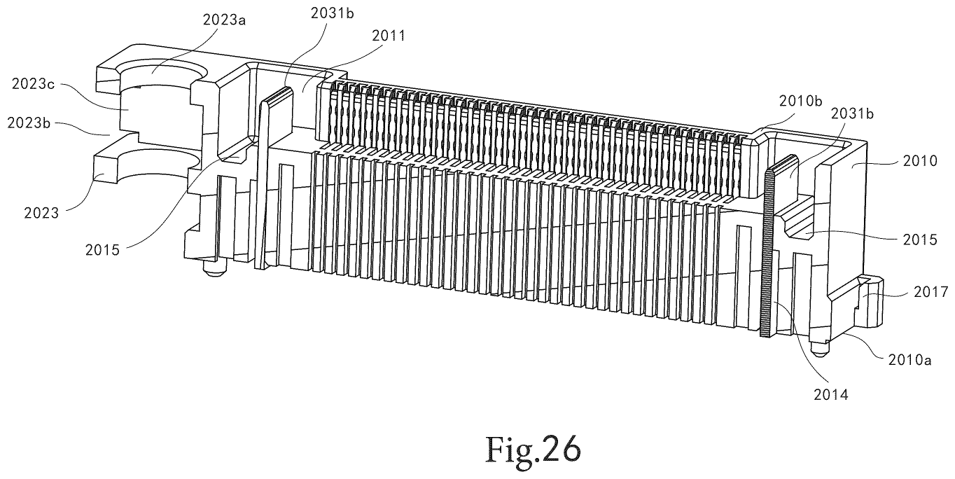

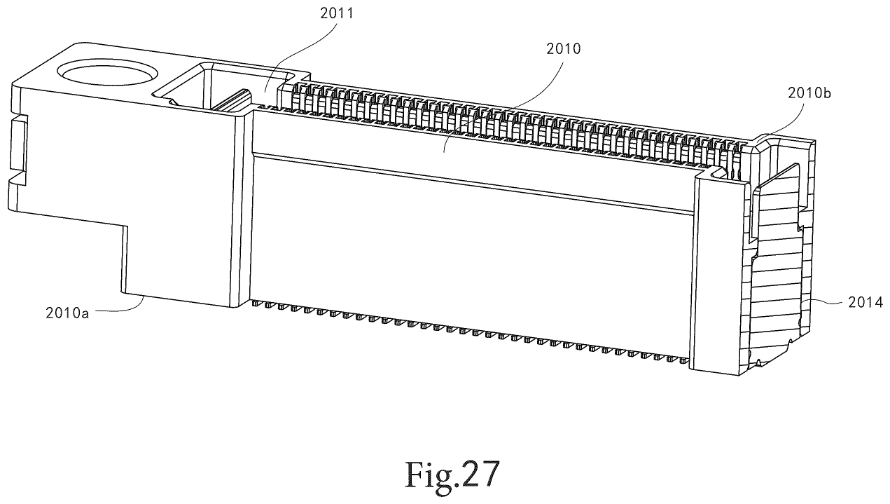

As shown by FIGS. 26 and 27, a power terminal channel 2014 is formed in the housing 2010 of the electrical connector 2000. For example, two power terminal channels 2014 are provided respectively at or adjacent to both ends of the signal terminal channels 2013 along the lengthwise direction of the housing 2010. The power terminal channels 2014 are configured to be in communication with the groove 2011 and extend from the groove 2011 to the first side 2010a of the housing 2010 along the heightwise direction of the housing 2010.

The mounting portion 2031a of a power terminal 2031 is formed with two bumps 2031c which are spaced from each other along a widthwise direction of the mounting portion, such that when the power terminal 2031 is installed in a respective power terminal channel 2014, the bumps 2031c will be snapped between sidewalls of a channel section of the power terminal channel 2014 to secure the power terminal 2031 in the power terminal channel 2014 in place. When the power terminal has been secured in place, only the insertion portion 2031b of the power terminal 2031 is exposed in the groove 2011, and an edge of the mounting portion 2031a of the power terminal 2031 opposing the insertion portion 2031b is exposed at the first side 2011a of the housing 2010 and can be configured to be attached onto the PCB 4000 using surface mount technology or reflow soldering technology.

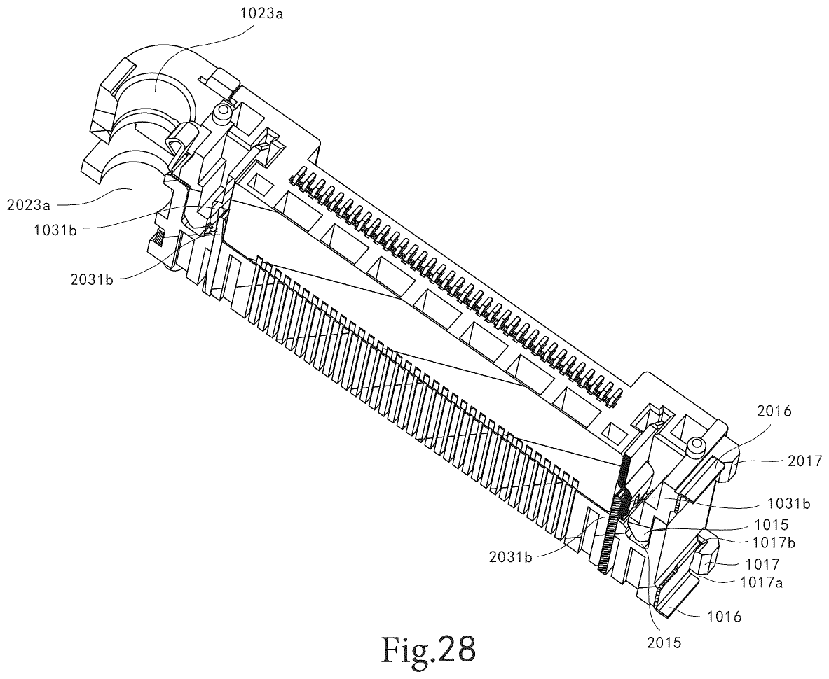

As shown by FIG. 28, when the tongue portion 1012 of the electrical connector 1000 has been contained in the groove 2011 of the electrical connector 2000 or the second side 1011b of the electrical connector 1000 has been in contact with the second side 2010b of the electrical connector 2000, the insertion portion 2031b of a power terminal 2031 can be suitably held by the two outermost clamping portions 1031b and the two middle clamping portions 1031b of a respective power terminal 1031 (only the two middle clamping portions 1031b visible in FIG. 28).

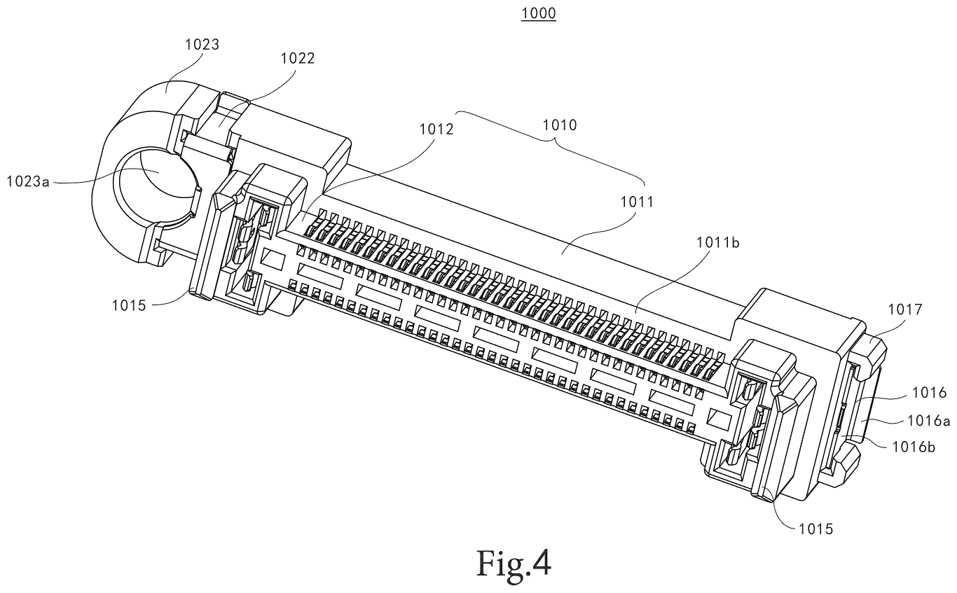

As shown by FIGS. 3 and 4, an alignment protrusion (or a contact protraction) 1015 is formed in the tongue portion 1012 of the electrical connector 1000. For instance, two alignment protrusions 1015 are formed there, as shown. The two alignment protrusions 1015 are configured such that the group of power terminals 1030 is located between the two alignment protrusions 1015 along the lengthwise direction of the housing 1010. For example, the two alignment protrusions 1015 can be located respectively at both ends of the tongue portion 1012 along the lengthwise direction of the housing 1010. The two alignment protrusions 1015 are formed asymmetrically relatively to a longitudinal central plane of the housing 1010. In the context of the present disclosure, the longitudinal central plane of the housing 1010 can be defined as a plane of symmetry between the two rows of signal terminals in the housing 1010. As shown by FIGS. 15 and 26, formed in the groove 2011 of the electrical connector 2000 is a receiving recess 2015, for example are two receiving recesses 2015. The two receiving recesses 2015 are configured such that they are located respectively at both ends of the groove 2011 along the lengthwise direction of the housing 2010. The two receiving recesses 2015 are formed asymmetrically relatively to a longitudinal central plane of the housing 2010. In the context of the present disclosure, the longitudinal central plane of the housing 2010 can be defined as a plane of symmetry between the two rows of signal terminals in the housing 2010. Furthermore, the receiving recesses 2015 and the alignment protrusions 1015 are configured such that the electrical connectors 1000 and 2000 are allowed to be connected to each other in a given orientation (as shown, for example) only, to ensure that the signal terminal assemblies and the power terminal assemblies of them come into respective contact with each other respectively in a specific alignment manner, to avoid damage to the electrical connectors caused by incorrect connection.

In an alternative or additional embodiment, a peripheral contour of the tongue portion 1012 of the electrical connector 1000 can be formed asymmetrically relative to the longitudinal central plane of the housing 1010, for example as shown. Moreover, an inner contour of the groove 2011 of the electrical connector 2000 is formed in a manner complementary to the peripheral contour of the tongue portion 1012 to ensure that the tongue portion 1012 can be contained in the groove 2011 in a given orientation only, to achieve Poka-Yoke connection between the electrical connectors 1000 and 200.

The complementary design between the alignment protrusions 1015 and the receiving recesses 2015 and/or between the peripheral contour of the tongue portion 1012 and the inner contour of the groove 2011 generally constitutes a Poka-Yoke connecting structure between the electrical connectors 1000 and 2000, to ensure that they can be connected to each other in a given orientation only. It should be understood be a person skilled in the art that in some embodiments only one alignment protrusion 1015 and only one receiving recess 2015 can be adopted; or the alignment protrusion(s) 1015 can be provided in the groove 2011 and the receiving recess(es) 2015 can be provided in the tongue portion 1012.

As shown by FIGS. 3 and 4, the electrical connector 1000 also comprises a first board holder 1016. For example, the first board holder 1016 as required can be inserted and held in a board holder seat 1017 formed at an end of the housing 1010 of the electrical connector 1000, and can be attached onto the PCB 3000 to achieve firm connection thereto. Similar to the electrical connector 1000, the electrical connector 2000 also comprises a first board holder 2016, and a board holder seat 2017 formed at an end of the housing 2010. Similar to the first board holder 1016, the first board holder 2016 as required can be inserted and held in the board holder seat 2017, and can be attached onto the PCB 4000 to achieve firm connection thereto. Therefore, the following description relevant to the first board holder 1016 and the board holder seat 1017 is also applicable to the first board holder 2016 and the board holder seat 2017.

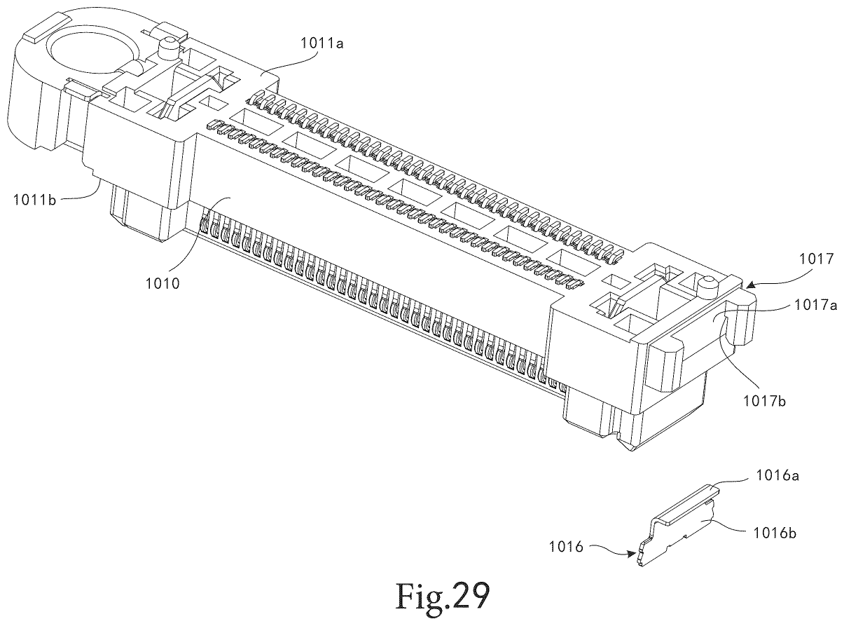

As shown by FIG. 29, the board holder 1016 is formed by bending a metal sheet, and has an insertion portion 1016b and a mounting portion 1016a extending from the insertion portion 1016b substantially at a right angle. For example, the insertion portion 1016b can have a segment as wide as the mounting portion 1016a (this segment directly connecting the mounting portion 1016a) and a widened segment. The board holder seat 1017 is formed in the base portion 1011, and has an opening 1017a as wide as the mounting portion 1016a and a slot 1017b formed adjacent to the opening 1017a. The slot 1017b has a width (measured along the widthwise direction of the housing) which is substantially equal to a width of the widened segment of the insertion portion 1016b. Therefore, when the first board holder 1016 is inserted into the board holder seat 1017 in a direction from the second side 1011b to the first side 1011a, the mounting portion 1016a can be exposed at the first side 1011a and the widened segment of the insertion portion 1016b can be securely snapped into the slot 1017b of the board holder seat 1017. The mounting portion 1016a of the first board holder 1016 can be configured to be attached onto the PCB 3000 using surface mount technology or reflow soldering technology.

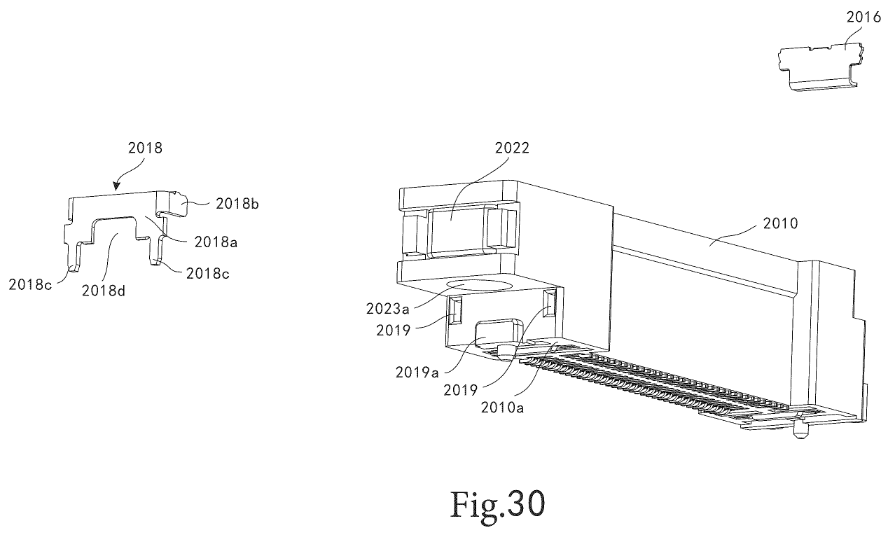

In addition to the first board holder 2016 and the board holder seat 2017, the electrical connector 2000 also comprises a second board holder 2018 functioning similar to the first board holder 2016, for optionally assistant-secured to the PCB 4000. As shown by FIG. 30, the second board holder 2018 is made by a metal sheet, and has a substantially planar body portion 2018a, two insertion arms 2018b extending substantially perpendicularly from both edges of the body portion 2018a respectively, and two mounting feet 2018c extending coplanar with the body portion 2018a. Therefore, a plane where the insertion arm 2018b locate is substantially perpendicular to a plane where the mounting feet 2018c. Two receiving holes 2019 are formed in an end of the housing 2010 opposing the first board holder 2016. The two receiving holes 2019 are spaced from each other by a distance which is substantially equal to a distance between the two insertion arms 2018b, such that the insertion arms 2018b of the second board holder 2018 can be suitably inserted into the receiving holes 2019 of the housing 2010 respectively. Upon the insertion arms inserted in place, the mounting feet 2018c of the second board holder 2018 can be exposed from the first side 2010a of the housing 2010, and can be configured to be attached onto the PCB 4000 surface mount technology or reflow soldering technology, to improve secure connection between the electrical connector 2000 and the PCB 4000.

In some embodiments, a notch 2018d is formed in the body portion 2018a, and a bulge 2019a is formed in the end of the housing 2010 and shaped in a manner complementary to the notch 2018d. When the insertion arms 2018b of the second board holder 2018 have been inserted in the receiving holes 2019 of the housing 2010, the bulge 2019a comes into contact with and is supported on an edge of the notch 2018d of the body portion 2018a, to further improve secure connection between the electrical connector 2000 and the PCB 4000. In some embodiments, in place of the first board holder 2016 and the board holder seat 2017, the second board holder 2018 and the receiving holes 2019 can be adopted in the electrical connector 1000.

As shown by FIGS. 1, 2 and 31, when the electrical connector 1000 carried with the PCB 3000 is connected to the electrical connector 2000 carried with the PCB 4000 by receiving the tongue portion 1012 in the groove 2011 in place, the locking member 5000 passes both of the electrical connectors 1000 and 2000 to further connect the two electrical connectors 1000 and 2000 firmly together and secure them relative to the PCB 3000. Therefore, in some embodiments, securing can be achieved by the locking member provided between the electrical connectors 1000 and 2000.

In some embodiments, the locking member 5000 can be in the form of a locking threaded piece having a head 5010, a connecting portion 5020 extending from the head 5010, and a threaded portion 5030 located at a free end of the connecting portion 5020. The head 5010 has an outer diameter which is greater than the connecting portion 5020 and the threaded portion 5030. The threaded portion 5030 has an outer diameter which is greater than the connecting portion 5020.

As shown by FIG. 3, a locking portion 1023 is formed at an end of the housing 1010 of the electrical connector 1000 opposing the end where the board holder seat 1017 is formed. The locking portion 1023 comprises a through hole 1023a which is formed from the first side 1011a to the second side 1011b along the heightwise direction of the housing 1010. The locking portion 1023 has a first side coplanar with the first side 1011a of the housing 1010 and a second side coplanar with the second side 1011b of the housing 1010. The locking portion 1023 also comprises two clamping slots 1023b which are provided respectively in both side parts of the locking portion 1023 along the widthwise direction of the housing. For example, the two clamping slots are configured to extend from the first side to the second side along the heightwise direction of the housing 1010.

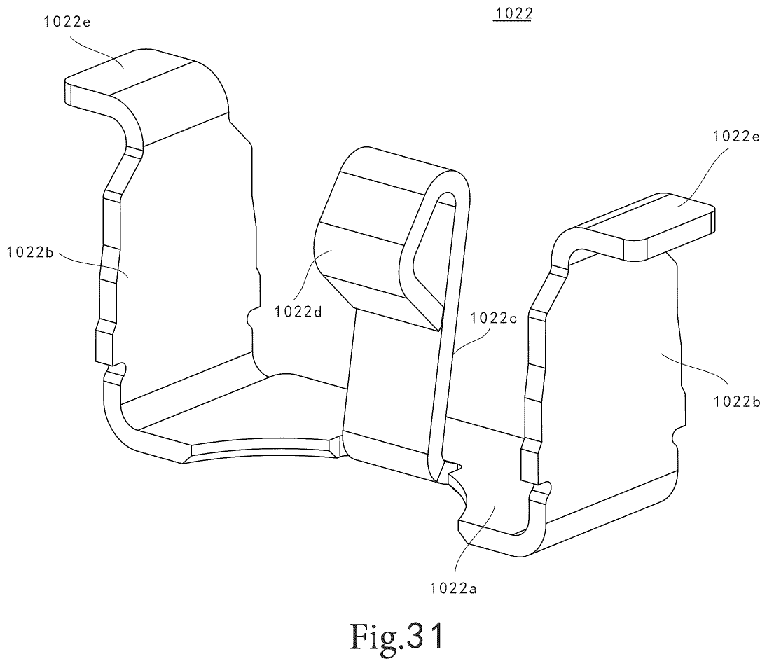

As shown by FIG. 31, the electrical connector 1000 comprises a holding member 1022 configured to keep the locking member 5000 and the electrical connector 1000 connected when a part of the locking member 5000 has passed the through hole 1023a of the locking portion 1023, to avoid the locking member released from the electrical connector by accident. The holding member 1022 can be made by a metal sheet, and has a body portion 1022a, and two flanks 1022b respectively extending substantially at a right angle from both sides of the body portion 1022a along a widthwise direction thereof. A mounting portion 1022e extends substantially perpendicularly from a free end of each flank 1022b. For example, two mounting portions 1022e extend substantially opposing each other. The two flanks 1022b can be snapped respectively into the clamping slots 1023b of the locking portion 1023 such that the mounting portion 1022e is exposed at the first side 1011a of the housing 1010 and can be configured to be attached onto the PCB 3000 surface mount technology or reflow soldering technology.

An arc-shaped edge is formed in the body portion 1022a. The arc-shape has a radius which is substantially equal to or greater than a radius of the through hole 1023a. When the holding member 1022 is secured relative to the locking portion 1023 by cooperation of the flanks 1022b with the clamping slots 1023b, a center of the edge's arc shape of the body portion 1022a coincides with a central axis of the through hole 1023a. The holding member 1022 also comprises a cantilever 1022c extending substantially perpendicularly from the arc-shaped edge of the body portion 1022a. The cantilever 1022c extends in the same direction as the flanks 1022b such that when the holding member 1022 has been secured relative to the locking portion 1023 in place, the cantilever 1022c can extend into the through hole 1023a of the locking portion 1023. In an unstressed state, the cantilever 1022c is substantially parallel to the central axis of the through hole 1023a in the through hole. A free end of the cantilever 1022c can be configured to further extend in a C-shaped manner to form an anti-release curved part 1022d. When the cantilever 1022c has been in the through hole 1023a in place, a vertical distance of the anti-release curved part 1022d from the central axis of the through hole 1023a is less than the radius of the threaded portion 5030 of the locking member 5000 but is greater than the radius of the connecting portion 5020 of the locking member 5000. Moreover, a distance of the cantilever 1022c in the through hole 1023a from the nearest inner wall of the through hole 1023a is provided such that the cantilever 1022c is enabled to deflect slightly radially outwards. After deflection, the vertical distance of the anti-release curved part 1022d from the central axis of the through hole 1023a is greater than the radius of the threaded portion 5030 of the locking member 5000.

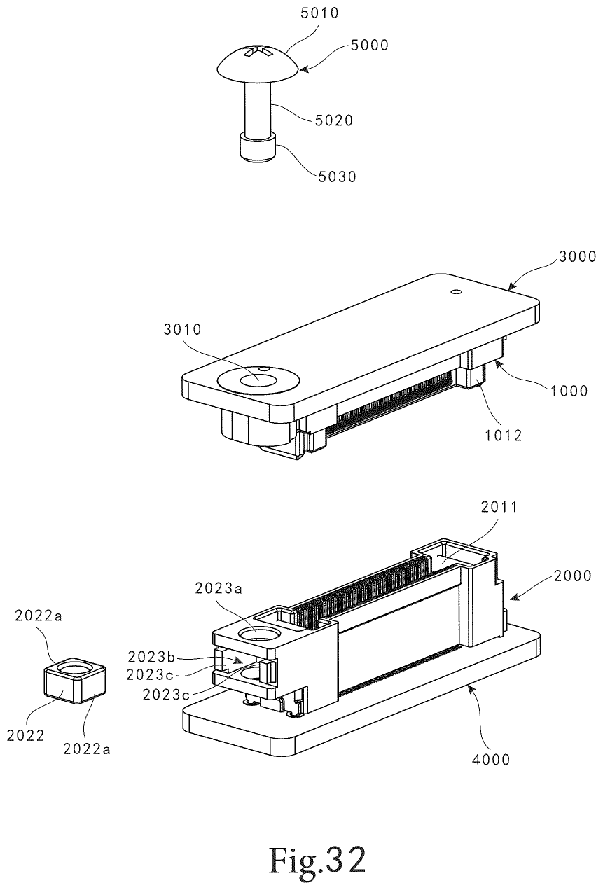

A through hole 3010 is formed in the PCB 3000. When the group of signal terminals and the group of power terminals of the electrical connector 1000 is attached onto the PCB 3000 using surface mount technology or reflow soldering technology, the through hole 3010 of the PCB 3000 aligns with the through hole 1023a of the locking portion 1023 coaxially. A diameter of the through hole 3010 and a diameter of the through hole 1023a are configured such that they are equal to or slightly greater than the outer diameter of the threaded portion 5030 respectively, thus facilitating the threaded portion 5030 passing the coaxially aligned through holes 3010 and 1023a. During the threaded portion 5030 passing the through hole 1023a (for example, from top to bottom as shown by FIG. 32), the threaded portion 5030 first contacts the anti-release curved part 1022d of the holding member 1022 such that the cantilever 1022c of the holding member 1022 deflects radially outwards, to enable the threaded portion 5030 to go over the anti-release curved part 1022d. Then, under elastic restoring action, the cantilever 1022c deflects radially inwards again to restore to its initial state such that the anti-release curved part 1022d restores to its initial state to prevent the threaded portion 5030 from being arbitrarily removed oppositely from the electrical connector 1000. Furthermore, due to the size design of the anti-release curved part 1022d, it when in the through hole 1023a will not affect screwing or unscrewing the connecting portion 5020. Therefore, now, the electrical connector 1000 can be connected and locked to another electrical connector such as the electrical connector 2000 using the locking member 5000 as required.

As shown by FIG. 11, the electrical connector 2000 comprises a locking portion 2023. Additionally, as shown by FIGS. 2 and 32, when the electrical connector 2000 is connected to the PCB 4000, the locking portion 2023 is in the form of an overhanging feature from the housing 2010 of the electrical connector 20000. In the heightwise direction of the housing 2010, the second board holder 2018 is located between the locking portion 2023 and the PCB 4000. In some embodiments, the locking portion 2023 is formed at an end of the housing 2010 of the electrical connector 2000 opposing the end where the board holder seat 2017 is formed.

As shown by FIGS. 26, 28, 30, and 32, the locking portion 2023 comprises a through hole 2023a extending along the heightwise direction of the housing 2010. The locking portion 2023 has a first side and a second side opposing and parallel to the first side, which second side is parallel to or coplanar with the second side 2010b of the housing 2010. For example, the through hole 2023a extends between the first side and the second side of the locking portion 2023 along the heightwise direction of the housing or extends only in the first side. When the electrical connectors 1000 and 2000 are connected to each other, the through hole 2023a coaxially aligns with the through hole 1023a. Furthermore, the locking portion 2023 also comprises a receiving cavity 2023b formed between the first side and the second side of the locking portion, to receive a retaining member 2022 (e.g., a nut). The through hole 2023a is in communication with the receiving cavity 2023b. A central axis of a threaded hole of the retaining member 2022, after placed in the receiving cavity 2023b, coincides with the central axis of the through hole 2023a and the retaining member 2022 is configured to be non-rotatable about the central axis in the receiving cavity 2023b. The receiving cavity 2023b is one-way opened. In some embodiments, the opening of the receiving cavity 2023b faces outwards along the lengthwise direction of the housing 2010. However, it should be understood by a person skilled in the art that in some embodiments, the opening of the receiving cavity 2023b can face outwards perpendicular to the lengthwise direction of the housing 2010. The retaining member 2022 can get in or out the receiving cavity 2023b via the opening of the receiving cavity 2023b. In some embodiments, a direction along which the retaining member 2022 can get in or out the receiving cavity 2023b is substantially perpendicular to the central axis of the through hole 2023a.

Two opposing contact walls 2023c are provided in the receiving cavity 2023b of the locking portion 2023. In the illustrated embodiment, the contact walls 2023c are substantially planar and parallel to each other, to contact two opposing and planar outer walls 2022a of the retaining member 2022 located in the receiving cavity 2023b respectively to prevent the retaining member 2022 from arbitrarily rotating in the receiving cavity 2023b. In some embodiments, the contact walls 2023c of the receiving cavity 2023b and the outer walls 2022a of the retaining member 2022 can be configured to be non-planar or non-circle shaped as long as the retaining member 2022 located in the receiving cavity 2023b is prevented from arbitrarily rotating by contact between the contact walls and the outer walls. The through hole 2023a has a diameter which is designed such that the threaded portion 5030 is allowed to pass the through hole, and which is less than an outer diameter of the retaining member 2022. That is, when placed in the receiving cavity 2023b, the retaining member 2022 is not allowed to pass the through hole 2023a. Inner threads of the threaded hole of the retaining member 2022 are configured to engage with outer threads of the threaded portion 5030.

In some embodiments, when the electrical connector 2000 is suitably connected to the electrical connector 1000 (for example by securing the tongue portion 1012 into the groove 2011 in place), the second side 1011b of the housing 1010 of the electrical connector 1000 comes into firm contact with the second side 2010b of the electrical connector 2000, and at the same time the through hole 2023a of the locking portion 2023 coaxially aligns with the through hole 1023a of the locking portion 1023. Therefore, the retaining member 2022 can be in advance or thereafter placed into the receiving cavity 2023b of the locking portion 2023 and the locking member 5000 can be screwed (for example by a (not-shown) screwdriver contacting the head 5010) to engage with the retaining member 2022. The locking member 5000 is screwed along such a direction that the retaining member 2022, which is non-rotatable about the central axis in the receiving cavity 2023b, to enable the head 5010 to move only towards electrical connector 2000. In this way, a locking force can be exerted between the head 5010 of the locking member 5000 and the retaining member 2022 to lock both of the electrical connectors and the PCB 3000 together. In some embodiments, the locking structure for example can comprise the locking member 5000, the retaining member 2022 and the holding member 1022.

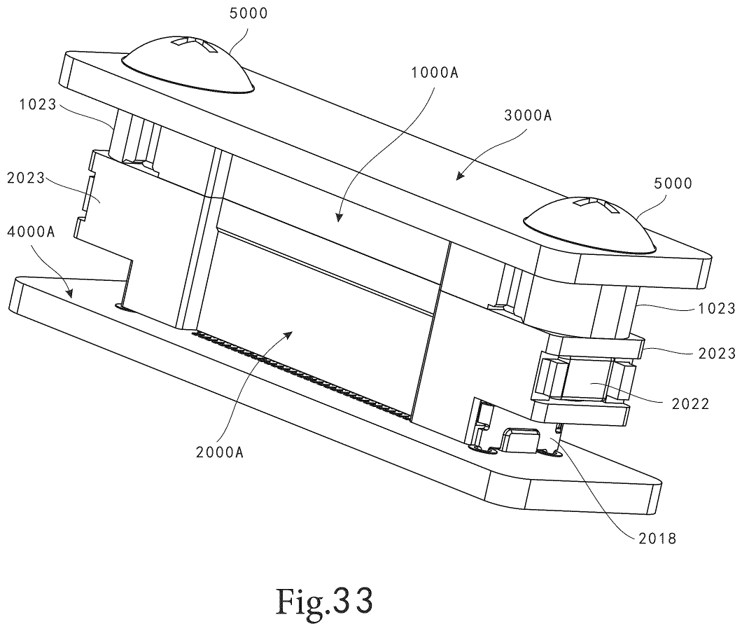

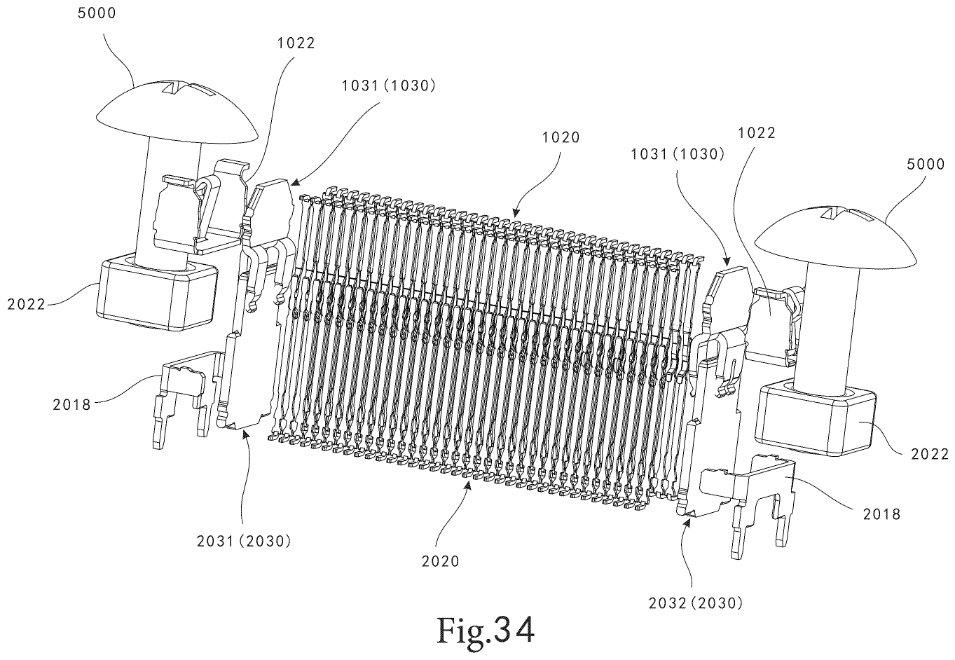

An electronic system generally comprised by a receptacle electrical connector 1000A, a plug electrical connector 2000A, a PCB 3000A, and a PCB 4000A according to another embodiment of the present disclosure is schematically shown by FIGS. 33 and 34, in which the receptacle electrical connector 1000A, the plug electrical connector 2000A and the PCB 3000A are locked together by two locking members 5000. A housing of the receptacle electrical connector 1000A is distinguished from the housing of the receptacle electrical connector 1000 only in that a locking portion 1023 and a holding member 1022 are equipped for each of both opposing ends of the housing of the receptacle electrical connector 1000A along a lengthwise direction thereof. Here, the locking portion 1023 and the holding member 1022 are configured in a manner similar to the embodiments described herein or their modifications. Besides, other features of the receptacle electrical connector 1000A such as the group of signal terminals 1020, the group of power terminals 130, channels for receiving terminals or the like are configured in a manner similar to the embodiments described herein or their modifications. A housing of the plug electrical connector 2000A is distinguished from the housing of the plug electrical connector 2000 only in that a locking portion 2023 and a retaining member 2022 are equipped for each of both opposing ends of the housing of the plug electrical connector 2000A such that they can cooperate with the two locking members 5000. The locking portion 2023 and the retaining member 2022 are configured in a manner similar to the embodiments described herein or their modifications. Besides, other features of the plug electrical connector 2000A such as the group of signal terminals 2020, the group of power terminals 2030, channels for receiving terminals, the second board holder 2018 or the like are configured in a manner similar to the embodiments described herein or their modifications.

In the embodiment as shown by FIG. 33, because the two locking members 5000 are used to lock the electrical connectors 1000A, 2000A and the PCB 3000A together at both ends, a greater locking force can be provided to meet more stringent locking requirements for applications, and at the same time to make sure that they can be locked securely.

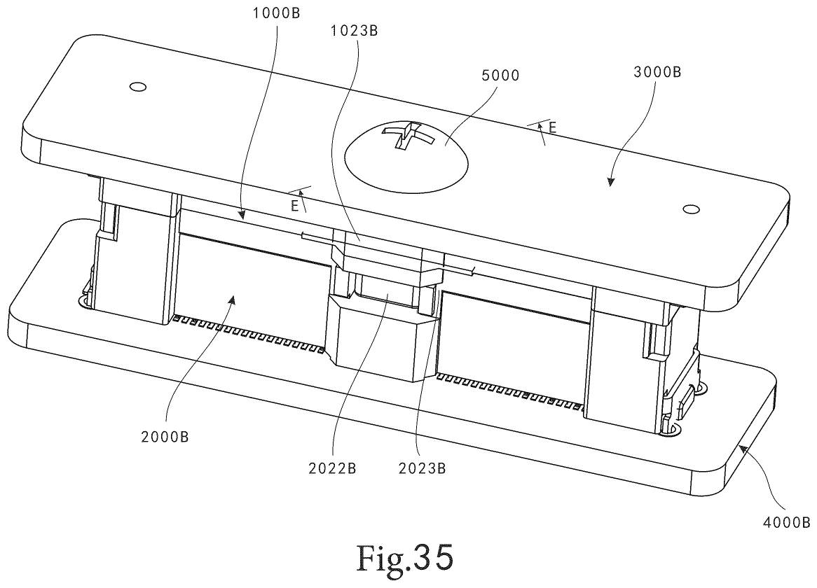

An electronic system generally comprised by a receptacle electrical connector 1000B, a plug electrical connector 2000A, a PCB 3000A, and a PCB 4000A according to another embodiment of the present disclosure is schematically shown by FIG. 35, in which the receptacle electrical connector 1000A, the plug electrical connector 2000A and the PCB 3000A are locked together by a locking member 5000.

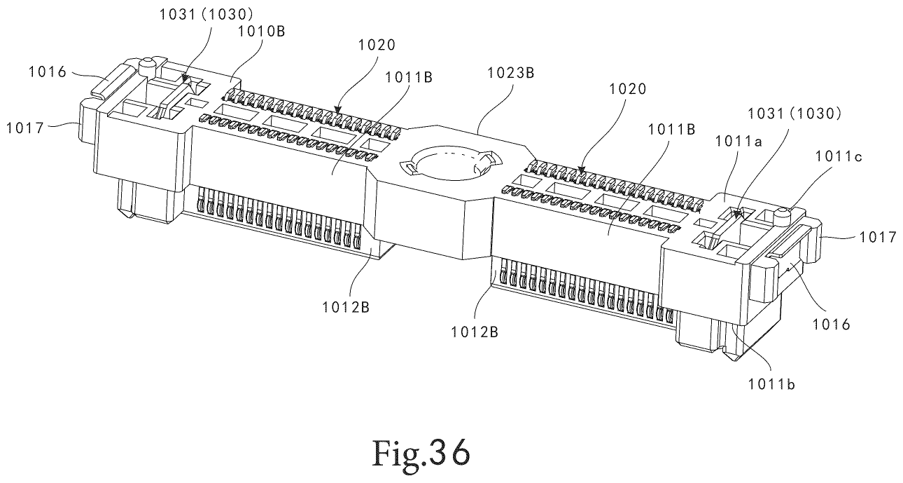

As shown by FIG. 36, the receptacle electrical connector 1000B substantially comprises a housing 1010B. For example, the housing 1010B is made of the same material as the housing 1010, and has two base portions 1011B and tongue portions 1012B extending from the two base portions 1011B respectively. The two base portions 1011B are connected integrally to each other by a locking portion 1023B. Therefore, the locking portion 1023B is located between both ends of the housing 1010B along a lengthwise direction of the housing 1010B. In the embodiment as shown, the locking portion 1023B is substantially at the middle of both ends of the housing 1010B.

The base portions 1011B and the tongue portions 1012B can be configured respectively in a manner similar to the base portion 1011 and the tongue portion 1012. Furthermore, the receptacle electrical connector 1000B comprises a group of signal terminals 1020 and a group of power terminals 1030. The group of signal terminals 1020 comprises signal terminals which are configured in a manner similar to the signal terminals 1021. The group of power terminals 1030 comprises power terminals which are configured in a manner similar to the already explained power terminals 1031. Moreover, the housing 1010B is formed with signal terminal channels and power terminal channels, which signal terminal channels and which power terminal channels can be configured respectively in a manner similar to the signal terminal channels 1013 and power terminal channels 1014.

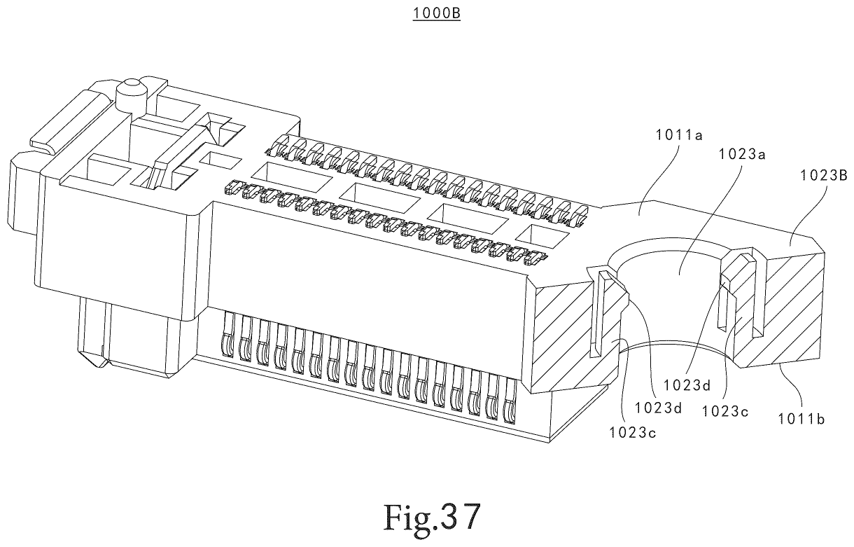

In some embodiments, the locking portion 1023B has two sides which are parallel to and oppose each other along the heightwise direction of the housing 1010B. The sides are parallel to or coplanar with the first side 1011a and the second side 1011b of the base portion 1011B respectively. Further as shown by FIG. 37, the locking portion 1023B comprises a through hole 1023a extending from the first side to the second side along the heightwise direction of the housing 1010B. A diameter of the through hole 1023a is sized such that the threaded portion 5030 of the locking member 5000 is allowed to pass the through hole 1023a but the head 5010 of the locking member 5000 is not allowed to pass the through hole 1023a. Two cantilevers 1023c are provided in the locking portion 1023B such that they are radially-symmetrical relative to a central axis of the through hole 1023a. The two cantilevers 1023c are configured such that they are able to deflect radially outwards or inwards relative to the central axis of the through hole 1023a. An anti-release bump 1023d is provided at a free end of each cantilever 1023c such that the anti-release bump extends radially inwards. In an unstressed state, the cantilevers 1023c are parallel to the central axis of the through hole 1023a therein, and a distance between two anti-release bumps 1023d is slightly less than the diameter of the threaded portion 5030 of the locking member 5000 but is greater than the diameter of the connecting portion 5020 of the locking member 5000.

A through hole 3010 is provided in the PCB 3000B. A diameter of the through hole 3010 is sized such that the threaded portion 5030 of the locking member 5000 is allowed to pass the through hole 3010 but the head 5010 of the locking member 5000 is not allowed to pass the through hole 3010. After the electrical connector 1000B is connected to the PCB 3000B, the through hole 3010 of the PCB 3000B coaxially aligns with the through hole 1023a of the locking portion 1023B. As such, the threaded portion 5030 of the locking member 5000 is enabled to pass the aligned through holes 3010 and 1023a in this order. During passing the through hole 1023a, the threaded portion 5030 first come into contact with the anti-release bumps 1023d such that the cantilevers 1023c deflect radially outwards. After the threaded portion 5030 has gone over the bumps 1023d, the cantilevers 1023c will deflect radially inwards under the action of their elastic restoring force, to enable the anti-release bumps 1023d to prevent the locking member 5000 from inadvertently releasing from the electrical connector 1000B connected with the PCB 3000B.

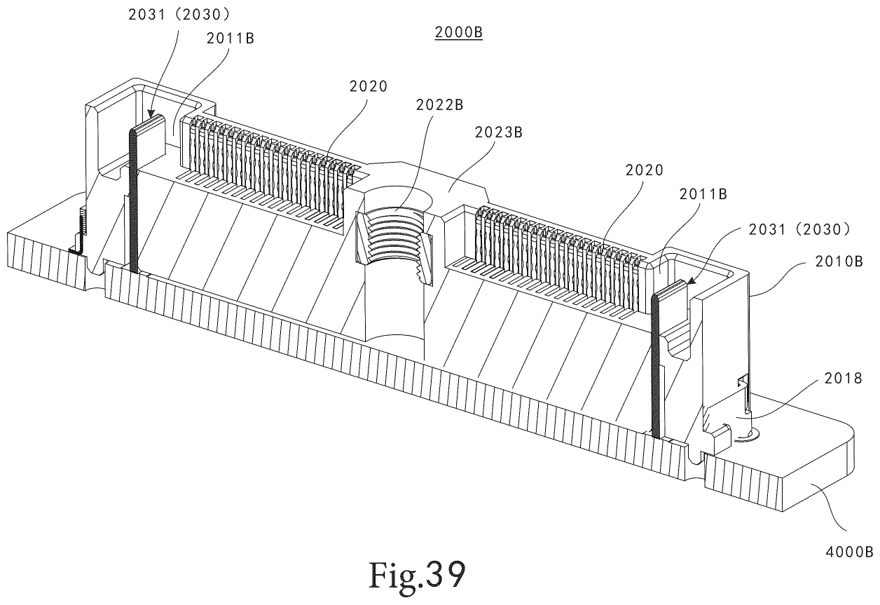

As shown by FIG. 39, the plug electrical connector 2000B comprises a housing 2010B. The housing 2010B can be made of the same material as the housing 2010. Two grooves 2011B are defined in the housing 2010B. The two grooves are formed in the same manner as the groove 2011, such that they are complementary to the two tongue portions 1012B of the receptacle electrical connector 1000B respectively. They are configured such that the electrical connectors 1000B and 200B are allowed to be connected to each other in a given orientation (for example, the orientation as shown) only to ensure that the signal terminal assemblies and the power terminal assemblies of both electrical connectors can be in contact with each other respectively in a specific alignment manner, to avoid damage to the electrical connectors caused by incorrect connection.

Furthermore, the plug electrical connector 2000B comprises a group of signal terminals 2020 and a group of power terminals 2030. The group of signal terminals 2020 can be comprised of signal terminals configured in the same manner as the signal terminals 2021. The group of power terminals 2030 can be comprised of power terminals configured in the same manner as the power terminals 2031. The housing 2010B is provided with signal terminal channels, which are configured in the same manner as the signal terminal channels 2013, and power terminal channels which are configured in the same manner as the power terminal channels 2014.

The two grooves 2011B are connected by a locking portion 2023B. For example, the locking portion 2023B can be configured in a manner similar to the locking portion 2023. The locking portion 2023B has a receiving cavity whose opening faces outwards perpendicular to a lengthwise direction of the housing 2010B. A retaining member 2022B is able to get in or out the receiving cavity via the opening of the receiving cavity. Furthermore, the locking portion 2023B also has a through hole in communication with the receiving cavity. When the electrical connectors 1000B and 2000B have been connected to each other in place, the through hole of the locking portion 2023B coaxially aligns with the through hole of the locking portion 1023B. In some embodiments, a direction, in which the retaining member 2022B is able to get in or out the receiving cavity of the locking portion 2023B, is substantially perpendicular to a central axis of the through hole of the locking portion 2023B. Similar to the retaining member 2022, the retaining member 2022B can be held such that it is non-rotatable about the central axis of the through hole in the receiving cavity of the locking portion 2023B.

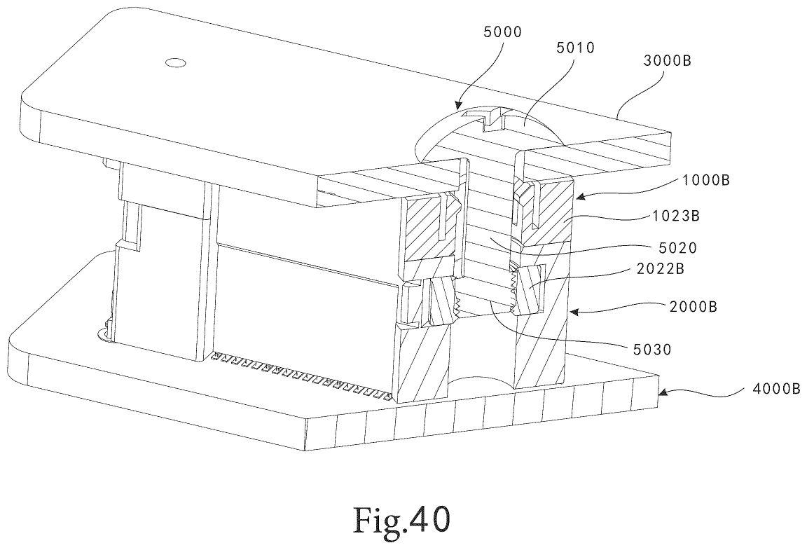

Therefore, as shown by FIG. 40, when the electrical connector 1000B carried with the PCB 3000 and the locking member 5000 is suitable connected to the electrical connector 2000B carried with the PCB 4000 in place, screwing the locking member 5000 will enable the head 5010 thereof to move only towards the electrical connector 2000B because the retaining member 2022B is non-rotatable about the central axis in the receiving cavity of the locking portion 2023B. In this way, a force to lock the two electrical connectors together with the PCB 3000 can be exerted between the head 5010 of the locking member 5000 and the retaining member 2022B. In some embodiments, the locking structure can comprise the locking member 5000 and the retaining member 2022B.

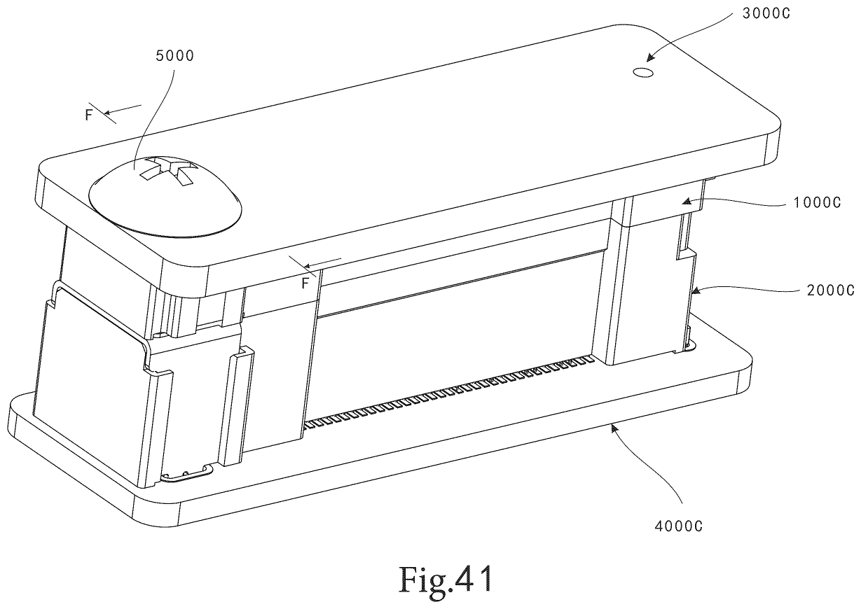

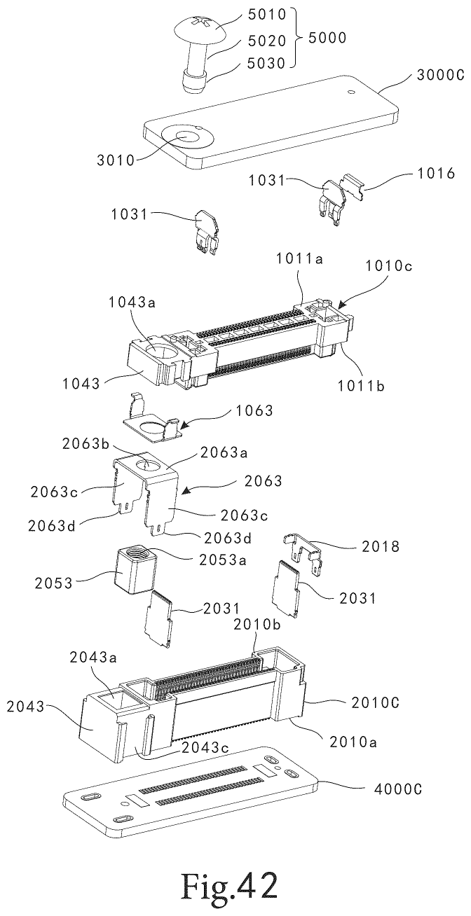

FIGS. 41 and 42 schematically shows an electronic system comprised of a receptacle electrical connector 1000C, a plug electrical connector 2000C, a PCB 3000C, and a PCB 4000C according to another embodiment of the present disclosure, in which the receptacle electrical connector 1000C, the plug electrical connector 2000C, and the PCB 3000C are locked together by a locking member 5000. As shown by FIG. 42, the receptacle electrical connector 1000C comprises a housing 1010C, and the plug electrical connector 2000C comprises a housing 2010C. The housing 1010C is formed in a manner similar to the housing 1010, and the housing 2010C is formed in a manner similar to the housing 2010. Therefore, the following will explain only the differences between the housings 1010C and 1010 and between the components installed thereon and the differences between the housings 2010C and 2010 and between the components installed thereon. The same characteristics between them can refer to the embodiments described herein or modifications thereof.

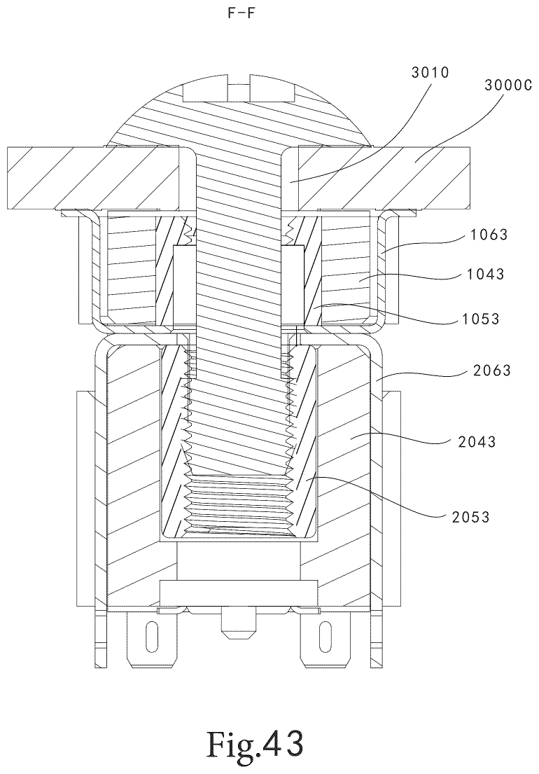

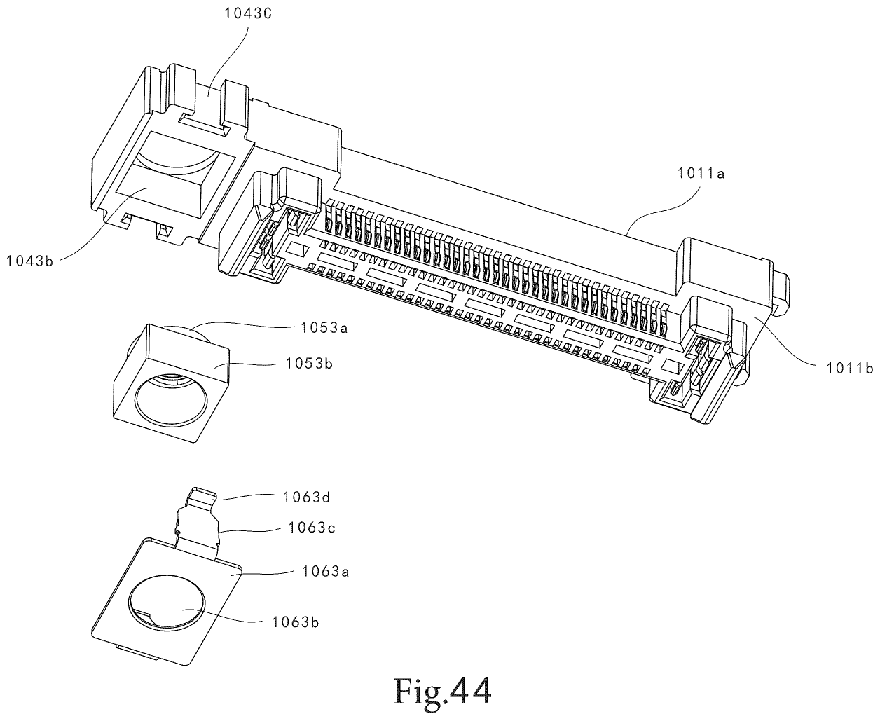

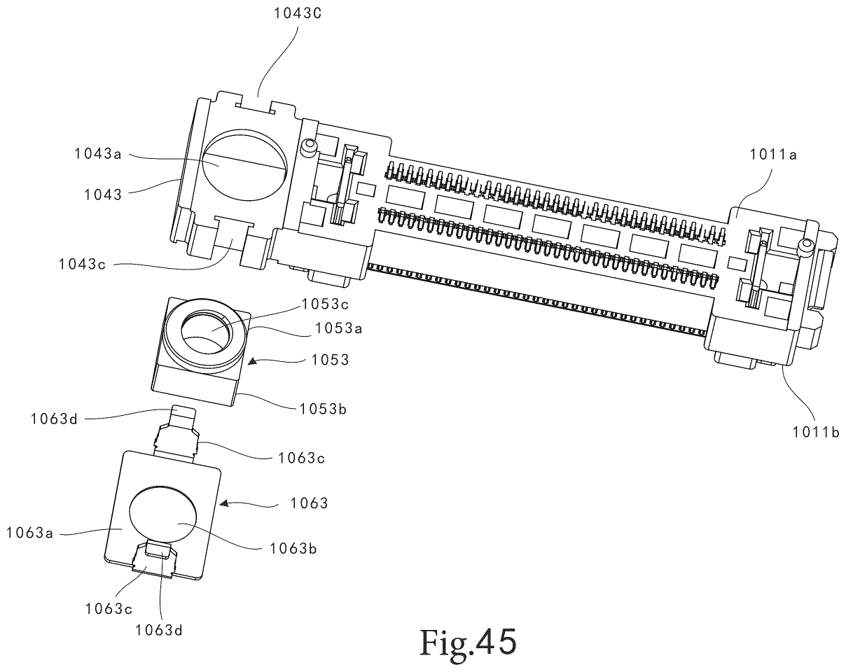

The housing 1010C of the receptacle electrical connector 1000C is integrally formed with a locking portion 1043 at one end. The locking portion 1043 has a first side which is coplanar with or parallel to a first side 1011a of a base portion of the housing 1010C, and a second side which is coplanar with or parallel to a second side 1011b of the base portion of the housing 1010C. A through hole 1034a is formed in the first side of the locking portion 1043. In the meanwhile, a cavity 1043b is formed in the locking portion 1043 from the first side thereof to the second side thereof along a heightwise direction of the housing 1010C. A threaded through member 1053 (which is hidden in FIG. 42 and visible in FIGS. 43, 44 and 45) is received rotational-fixedly about a central axis in the cavity 1043b of the locking portion 1043. For example, the threaded through member 1053 can be made of a metal material.

For example, along the heightwise direction, the threaded through member 1053 has a first section 1053a and a second section 1053b. The first section 1053a has a peripheral contour matching with an inner wall shape of the through hole 1043a. For example, both of them are cylinder-shaped. Moreover, the first section 1053a has a height which is substantially equal to a height of the through hole 1043a such that when the second section 1053b of the threaded through member 1053 is received in the cavity 1043b, the first section 1053a is just located in the through hole 1043a. A threaded hole 1053c is formed in the first section 1053a. Internal threads of the threaded hole 1053c are configured to engage with external threads of a threaded portion 5030 of the locking member 5000. Furthermore, an inner wall of the cavity 1043b is formed in such a way that it is non-cylinder-shaped, and an outer wall of the second section 1053b of the threaded through member 1053 is shaped in such a way that it is complementary to the inner wall of the cavity 1043b. The second section 1053b is hollow, and has an internal diameter which is greater than a diameter of the threaded portion 5030 of the locking member 5000. In the shown embodiment, the outer wall of the second section 1053b of the threaded through member 1053 can be square-shaped, and the inner wall of the cavity 1043b can be respectively square-shaped.

When the electrical connector 1000C is assembled, the threaded through member 1053 is inserted into the cavity 1043b of the locking portion 1043 along a direction from the second side to the first side. In order to prevent the threaded through member 1053 from falling out of the cavity 1043b, a first cover 1063 is provided. For example, the first cover 10653 can be made of a metal material. As shown, the first cover 1063 has a body portion 1063a. A through hole 1063b is formed in the body portion 1063a. The body portion 1063a is substantially cube-shaped or cuboid-shaped. Two flanks 1063c are configured to extend from two edges of the body portion 1063a respectively in such a way that the two flanks are substantially perpendicular to a plane where the body portion locates. A distance measured between the two flanks 1063c is equal to or slightly less than a width of the locking portion 1043. Two substantially vertical mounting portions 1063d extend from free ends of the two flanks 1063c respectively. For example, the two mounting portions 1063d extend in opposite directions respectively. Two receiving slots 1043c are formed in both sides of the locking portion 1043 along a widthwise direction of the housing 1010C, to receive the flanks 1063c, respectively.

The through hole 1063b of the first cover 1063 has an internal diameter which is greater than the diameter of the threaded portion 5030 of the locking member 5000 such that the threaded portion 5030 can freely pass the through hole 1063b. However, the internal diameter of the through hole 1063b of the first cover 1063 is less than an internal diameter of the second section 1053b of the threaded through member 1053. Therefore, when the threaded through member 1053 is inserted in the cavity 1043b of the locking portion 1043, the first cover 1063 can be installed to the locking portion 1043 in such a way that the body portion 1063a of the first cover comes into contact with the second side of the locking portion 1043 to prevent the threaded through member 1053 from inadvertently falling out of the cavity 1043b. As the distance measured between the two flanks 1063c can be slightly less than the width of the locking portion 1043, the two flanks 1063c, when inserted into the receiving slots 1043c respectively, can be used to clamp the locking portion 1043 to achieve a temporary fixation function. Upon installed in place, the two mounting portions 1063d of the first cover 1063 are exposed on the first side 1010a of the housing 1010C and can be configured to be attached onto the PCB 3000C using surface mount technology or reflow soldering technology. When the electrical connector 1000C is connected to the PCB 3000C in place, the through hole 3010 of the PCB 3000C is coaxial with the through holes of the threaded through member 1053 and the first cover 1063.

The housing 2010C of the plug electrical connector 2000C is integrally formed with a locking portion 2043 at one end. The locking portion 2043 has a first side, which is substantially coplanar with or parallel to a first side 2010a of the housing 2010C, and a second side which is substantially coplanar with or parallel to a second side 2010b of the housing 2010C. A cavity 2043a is formed in the locking portion 2043 to have an opening in the second side. A retaining member 2053 can be received in the cavity 2043a through the opening. An outer wall of the retaining member 2053 and an inner wall of the cavity 2043a can be formed in such a way that they are complementary to each other and are non-circle shaped. For example, in the shown embodiment, they are square-shaped. Therefore, the retaining member 2053 can be received in the cavity 2043a in such a way that the retaining member is non-rotatable about its central axis. A second cover 2063 is provided to prevent the retaining member 2053 from inadvertently falling out of the cavity 2043a. The second cover 2063 for example can be made by a metal material and has a body portion 2063a. The body portion 2063a is planar and is for example square or rectangular. Two flanks 2063c extend from two edges of the body portion 2063a respectively substantially perpendicular to a plane where the body portion locates. A distance measured between the two flanks 2063c is slightly less than a width of the locking portion 2043. Mounting portions 2063d extend from free ends of the two flanks 2063c respectively. Two receiving slots 2043c (only one of which is visible in FIG. 42) are formed in both sides of the locking portion 2043 along a widthwise direction of the housing 2010C respectively, to receive the two flanks 2063c.

A through hole 2063b is formed in the body portion 2063a of the second cover 2063. After the retaining member 2053 is inserted in the cavity 2043b of the locking portion 2043 and the second cover 2063 is installed to the locking portion 2043 in such a way that the body portion 2063a of the second cover comes into contact with the second side of the locking portion 2043, the through hole 2063b is coaxial with a threaded hole 2053a of the retaining member. Internal threads of the threaded hole 2053a are configured to engage with the external threads of the threaded portion 5030 of the locking member 5000. The through hole 2063b has an internal diameter which is configured such that the threaded portion 5030 of the locking member 5000 can freely pass the through hole 2063b and the retaining member 2053 is prevented from passing the body portion 2063a of the second cover 2063. When the second cover 2063 is installed in place, the mounting portions 2063d thereof are exposed at the first side 2010a of the housing 2010C and can be configured to be attached onto the PCB 4000C using surface mount technology or reflow soldering technology.

When the PCB 3000C is connected to the electrical connector 1000C, the threaded portion 5030 of the locking member 5000 can pass the through hole 3010 of the PCB 3000C and can be screwed to pass the threaded though member 1053. After exposed at the first side 1010a of the electrical connector 1000C, the threaded portion cannot be inadvertently released from the locking portion 1043 by simply pulling the locking member. In addition to prevent inadvertent releasing, the threaded through member 1053 can increase the ability to withstand the locking force because it can be made of a material, such as a metal material, which is harder than the housing. In this way, when the electrical connector 1000C carried with the locking member 5000 and the PCB 3000C is suitably connected to the electrical connector 2000C carried with the PCB 4000C and the retaining member 2053 in place, the threaded through member 1053 is coaxial with the retaining member 2053. The locking member 5000 is screwed such that its head 5010 engages with the retaining member 2053. As the retaining member 2053 is non-rotatable relative to the housing 2010C, the retaining member 2053 is driven to move towards the housing 1010C only, thus exerting a force between the head 5010 of the locking member 5000 and the retaining member 2053 to lock the two electrical connectors together with the PCB 3000C. In some embodiments, the locking structure can for example comprise the locking member 5000, the retaining member 2053 and the threaded through member 1053.

In some embodiments, the locking portion 1043, the threaded through member 1053, and the first cover 1063 can be provided at either end of the housing 1010C, and the locking portion 2043, the retaining member 2053, and the second cover 2063 can be provided at either end of the housing 2010C such that two locking members 5000 can be adopted at both ends of the electrical connectors respectively to lock the two electrical connectors together with the PCB 3000C.

In some embodiments, the board holder seat 2017 of the housing 2010 can be for example replaced by the locking portion 1023 and at the same time the locking portion 2023 for receiving the retaining member 2022 can be provided at a respective end of the housing 1010 such that an additional locking member 5000 can be used to pass the PCB 4000 to lock the electrical connectors 1000, 2000 together with the PCB 4000. In some embodiments, the board holder seat of the housing 2010C can be replaced by the locking portion 1043 and the board holder seat of the housing 1010C can be replaced by the locking portion 2043. In this way, by correspondingly providing a threaded through member, a retaining member, a first cover, and a second cover, an additional locking member can be used to pass the PCB 4000C to lock the electrical connectors 1000C, 2000C together with the PCB 4000C.

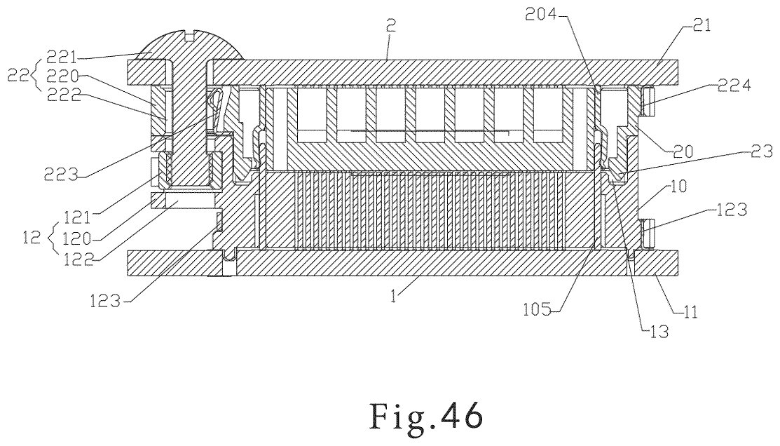

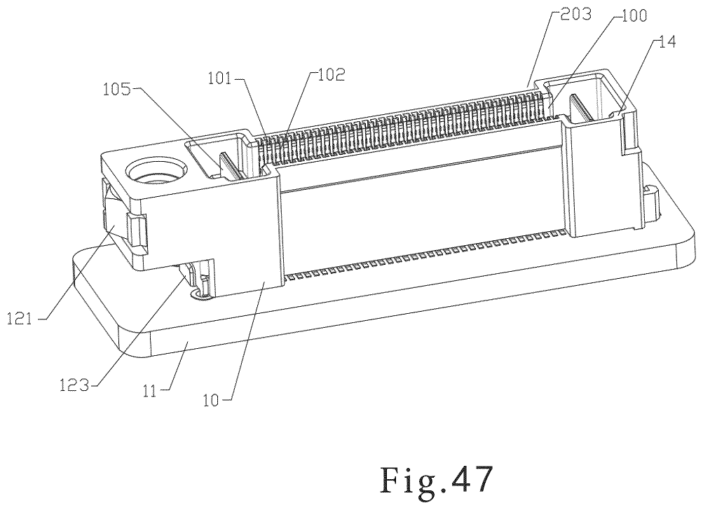

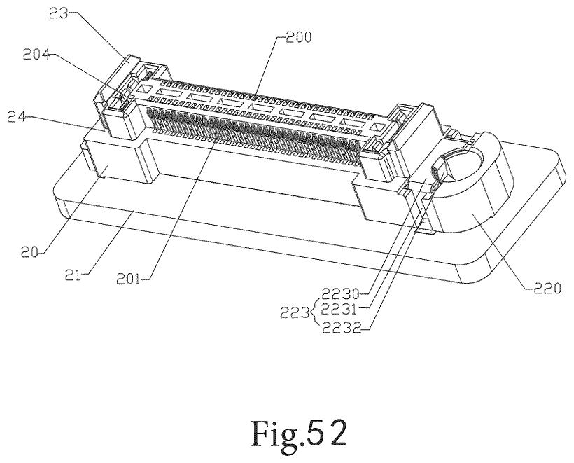

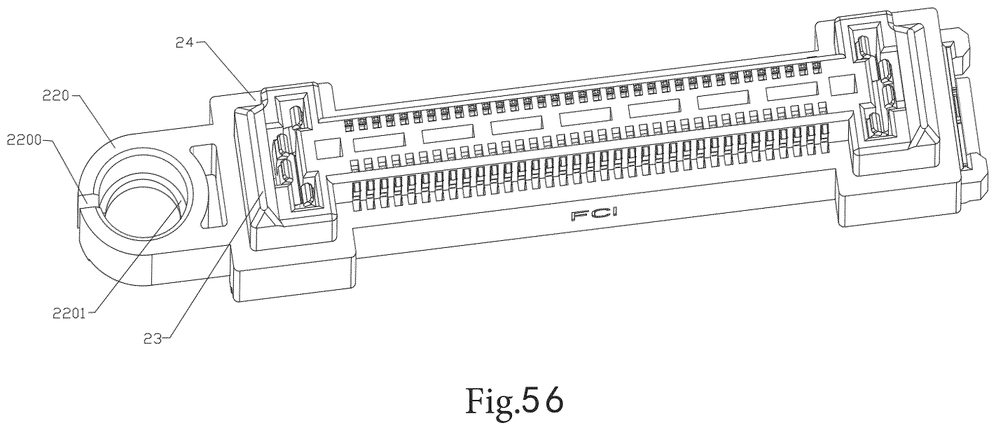

Further as shown by FIGS. 46 to 56, the present disclosure also proposes electrical connectors for stable connection with small pitches and high-frequency comprising a male electrical connector 1 and a female electrical connector 2 which are configured to mate with each other. The male electrical connector 1 comprises a male plastic body 10 and a male PCB 11. The female electrical connector 2 comprises a female plastic body 20 and a female PCB 21. The male plastic body 10 has a male receptacle 100 which is opened at one end. The male receptacle 100 is formed with male terminal receiving slots 101 in both sides respectively. Male signal terminals 102 are received in the male terminal receiving slots 101. Correspondingly, the female plastic body is formed with female terminal receiving slots 200 in which female signal terminals 201 are received respectively. When the male electrical connector is connected to the female electrical connector 2, the male signal terminals 102 are in electrical contact with the female signal terminals 201 at respective ends, and opposing respective ends thereof departing away from each other can be attached onto the male PCB and the female PCB respectively.

The concrete shapes of the male plastic body 10 and the female plastic body 20 in the present disclosure are not limited to those as show by the drawings of the present disclosure. The male plastic body 10 and the female plastic body 20 as shown by the drawings of the present disclosure are “dumbbell”-shaped. The “dumbbell” shape is formed by cutting recessed portions at the middle of both sides of the male plastic body 10 and the female plastic body 20 respectively. This kind of shape can facilitate cutting respective signal terminals and reduce the difficulty of processing and assembly.

Further, in an embodiment, the male electrical connector 1 and the female electrical connector 2 also comprise power terminals for transmission of electrical currents. Specifically, male power terminals 105 are provided at both ends of the male signal terminals 102 in the male plastic body 10. The male power terminals 105 are planar. Correspondingly, female power terminals 204 are provided at both ends of the female signal terminals 204 in the female plastic body 20. The female power terminals 204 have resilient arms. When the male electrical connector 1 is connected to the female electrical connector, the planar male power terminals 105 are inserted into spaces defined by the resilient arms of the female power terminals 204 to be electrically connected to them. In the embodiment, the male electrical connector 1 and the female electrical connector 2 are provided at heads of the “dumbbell” shapes of the male plastic body 10 and the female plastic body 20 respectively.

Of courses, in other embodiments, it is feasible for the male electrical connector 1 and the female electrical connector 2 not to comprise the respective power terminals. That is, they have the signal terminals only. The electrical connectors in the embodiment can be used to transmit both of electrical currents and signals.

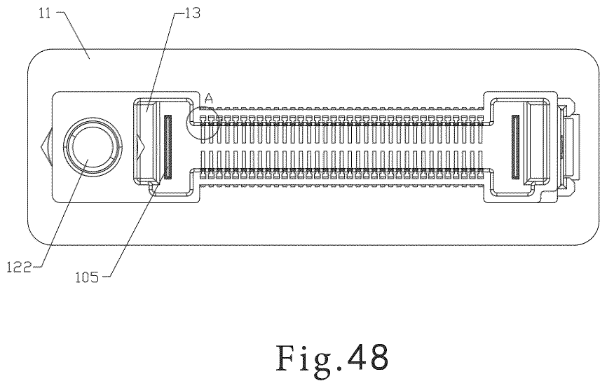

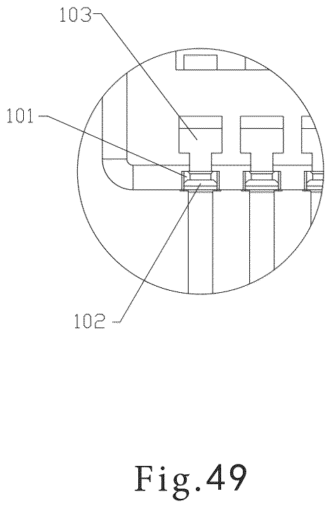

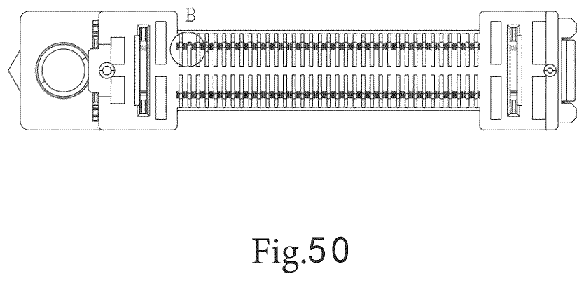

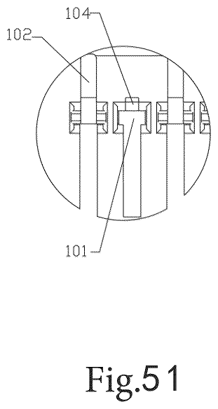

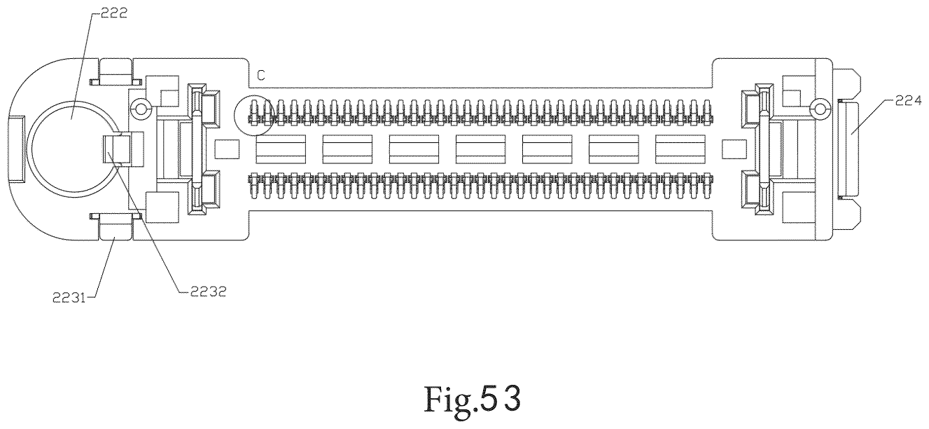

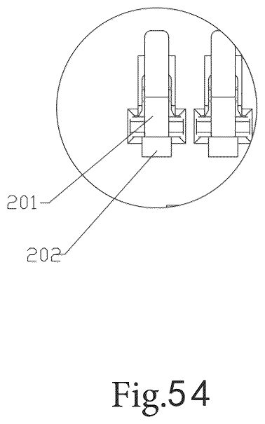

Furthermore, in order to improve high-frequency performance, a first dielectric slot 103 opens in a top end face of a male terminal receiving slot 101, as shown by FIGS. 48 and 49. Moreover, a second dielectric slot 104 opens in a bottom end face of a male terminal receiving slot 101, as shown by FIGS. 50 and 51. Moreover, a third dielectric slot 202 opens in a bottom end face of a female terminal receiving slot 200, as shown by FIGS. 53 and 54. Providing a “gap” structure between a male signal terminal 102 and a male terminal receiving slot 101 and between a female signal terminal 201 and a female terminal receiving slot 200 can reduce the corresponding dielectric coefficient to improve high-frequency performance of the electrical connector.

Furthermore, the electrical connector according to the present disclosure also comprises a blind insertion feature and a Poka-Yoke feature, as shown by FIGS. 46, 47, 52, 54 and 55. The blind insertion feature comprises blind insertion chambered protrusions 23 provided at both ends on the top end face of the female plastic body 20 and corresponding blind insertion chambered recesses 13 provided on the bottom of the male plastic body 10. The Poka-Yoke feature comprises a Poka-Yoke protrusion 14 projecting from an inner side of a side wall of the male plastic body 10 and a Poka-Yoke groove 24 correspondingly provided in the female plastic body 20.

The benefits of the present disclosure include but are not limited to: a lock-board structure provided to achieve reliable connections between the male and female electrical connectors and between the female plastic body, the female signal terminals, the female power terminals and the female PCB. The lock-board structure is more simplified than a conventional locking structure. The lock-board structure comprises a first lock-board assembly 12 and a second lock-board assembly 22. The first lock-board assembly 12 and the second lock-board assembly 22 are provided on at least one side of the male plastic body 10 and the female plastic body 20 respectively. In some embodiments, the first lock-board assembly 12 is provided on the male electrical connector 1, and the second lock-board assembly 22 is provided on the female electrical connector 2. The male plastic body 10 and the male PCB 11, the female plastic body 20 and the female PCB 21, and the male electrical connector 1 and the female electrical connector 2 can be locked together using the first lock-board assembly 12 and the second lock-board assembly 22.

Specifically, the first lock-board assembly 12 comprises a first lock-board body 120 and a lock-board nut 1221. The first lock-board body 120 is formed such that it extends outwards from at least one side of the male plastic body 10. One or two lock-board structures can be provided. In the shown embodiment, only one lock-board structure is provided. The first lock-board body 120 is formed with a first through hole 122, and the lock-board nut 121 is provided at one end of the through hole 122.

Moreover, the second lock-board assembly 22 comprises a second lock-board body 220 and a lock-board bolt 221. The second lock-board body 220 is formed such that it extends outwards from the female plastic body 20. The second lock-board body 220 is formed with a second through hole 222. The lock-board bolt 221 is configured to pass the second through hole 222 and/or the first through hole 122 to threadedly engage with the lock-board nut 121.

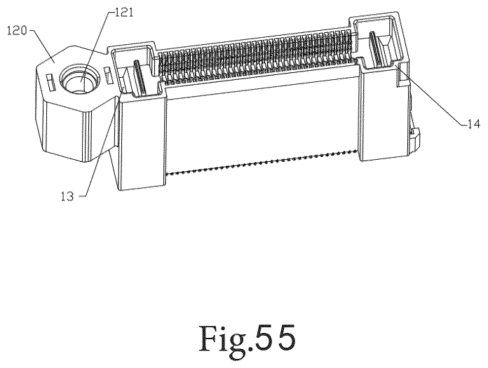

An optional embodiment one As shown by FIGS. 54 and 55, in the embodiment, the second through hole 222 is opened with a notch 2220. The notch 2220 extends axially and extends radially from the second through hole 222 to an outer side of the second lock-board body 220. Moreover, an anti-release step 2221 is provided in the second through hole 222; and correspondingly, the lock-board bolt is also provided with an anti-release boss such that before locking with the lock-board nut, the lock-board bolt can be located in the second through hole to be prevented from dropping therefrom and thus losing.

In an embodiment, the male plastic body 10 and the female plastic body 20 formed with the lock-board structure is not provided with a corresponding male latch 123 and a female latch 124 respectively at one end, and is provided only at the other end with a male latch 123 to secure the male plastic body 10 on the male PCB 11 and a female latch 224 to secure the female plastic body 20 on the female PCB 21.

In the embodiment, the lock-board bolt can be integrally formed on a side of the first through hole.

As shown by FIGS. 46, 47 and 52, in the embodiment, male latches 123 are provided at both ends of the male plastic body 10 respectively. Therefore, a male latch 123 is provided at one end of the male plastic body 10 formed with the first lock-board assembly 12, and a female latch 224 is provided at one end of the female plastic body 10. Moreover, the female plastic body 20 formed with the second lock-board assembly 22 is provided with a second strip 223 at one end.

Specifically, the second strip 223 comprises a second strip body 2230 and second feet 2231 extending downwards from both ends of the second strip body 2230. The second strip body 2230 is arranged on a top surface of the second lock-board body 220. The two feet 2231 are arranged onto two side walls of the second lock-board body 2230 respectively. Furthermore, the second strip 223 also comprises an intermediate resilient plate 2232. The intermediate resilient plate 2232 extends downwards from the middle of the second strip body 2230., and the intermediate resilient plate 2232 is arranged to a side wall of the second through hole 222. When the lock-board bolt 221 is inserted in the second through hole 222, the intermediate resilient plate 2232 is deformed such that it will exert a counter-acting force onto the lock-board bolt 221 to prevent the lock-board bolt 221 from dropping to some extents.

In the embodiment, the second through hole 222 is not opened with the notch of the embodiment one. The second strip 223 is provided to further secure the female plastic body 20 and the female PCB 21 together and to prevent the lock-board bolt 221 from dropping.

In the embodiment, the lock-board nut 121 is releasably connected to the first lock-board body 120. That is, it can be placed into the first through hole 122 from a side of the first lock-board body 120.

It should be understood that various alterations, modifications, and improvements may be made to the structures, configurations, and methods discussed above, and are intended to be within the spirit and scope of the invention disclosed herein. Further, although advantages of the present invention are indicated, it should be appreciated that not every embodiment of the invention will include every described advantage. Some embodiments may not implement any features described as advantageous herein. Accordingly, the foregoing description and attached drawings are by way of example only.

It should be understood that some aspects of the present technology may be embodied as one or more methods, and acts performed as part of a method of the present technology may be ordered in any suitable way. Accordingly, embodiments may be constructed in which acts are performed in an order different than shown and/or described, which may include performing some acts simultaneously, even though shown and/or described as sequential acts in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the description and the claims to modify an element does not by itself connote any priority, precedence, or order of one element over another, or the temporal order in which acts of a method are performed, but are used merely as labels to distinguish one element or act having a certain name from another element or act having a same name (but for use of the ordinal term) to distinguish the elements or acts.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein in the specification and in the claims, the phrase “equal” or “the same” in reference to two values (e.g., distances, widths, etc.) means that two values are the same within manufacturing tolerances. Thus, two values being equal, or the same, may mean that the two values are different from one another by ±5%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,”when used in the claims, shall have its ordinary meaning as used in the field of patent law.

Also, the phraseology and terminology used herein is for the purpose of description and should not be regarded as limiting. Use of terms such as “including,” “comprising,” “comprised of,” “having,” “containing,” and “involving,” and variations thereof herein, is meant to encompass the items listed thereafter and equivalents thereof as well as additional items.

The terms “approximately” and “about” if used herein may be construed to mean within ±20% of a target value in some embodiments, within ±10 % of a target value in some embodiments, within ±5% of a target value in some embodiments, and within +2% of a target value in some embodiments. The terms “approximately”and “about”may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

What is claimed is:

1. An electrical connector comprising:
a housing comprising an elongated portion;
a plurality of signal terminals held by the elongated portion of the housing in a row, each of the plurality of signal terminals comprising a mating portion, a mounting portion, and an intermediate portion between the mating portion and the mounting portion;
the elongated portion of the housing comprises a wall comprising a plurality of channels;
the plurality of signal terminals are disposed in respective channels of the plurality of channels; and
each of the plurality of channels comprises a gap between a respective signal terminal and the wall, the gap extending beyond the intermediate portion of the respective signal terminal.

2. The electrical connector of claim 1, comprising:
a first power terminal disposed at a first end of the plurality of signal terminals; and
a second power terminal disposed at a second end of the plurality of signal terminals, the second end opposite the first end,
wherein the first and second power terminals extend in parallel to each other and perpendicular to the row.

3. The electrical connector of claim 2, wherein:
the housing comprises first and second end portions on opposite ends of the elongated portion, each of the first and second end portions comprising a slot elongated in a direction perpendicular to the row; and
the first and second power terminals are held in the slots of the first and second end portions of the housing, respectively.

4. The electrical connector of claim 3, wherein:
each of the first and second end portions are shaped asymmetrically relative to a longitudinal central plane of the housing.

5. The electrical connector of claim 4, wherein:
each of the first and second power terminals comprises a blade-shaped mounting portion, and a mating portion configured for clamping engagement with a mating portion of a mating connector.

6. The electrical connector of claim 5, wherein:
the mating portion of each of the first and second power terminals comprises a plurality of beams configured to clamp with a blade of the mating connector.

7. The electrical connector of claim 1, wherein:
the housing comprises one or more locking portions each configured to receive a locking member.

8. The electrical connector of claim 7, wherein:
the one or more locking portions comprise a locking portion disposed within the elongated portion.

9. The electrical connector of claim 7, wherein:
the one or more locking portions comprise a locking portion disposed at an end of the elongated portion.

10. The electrical connector of claim 7, comprising:
one or more holding members each corresponding to a respective locking portion of the one or more locking portions of the housing, the one or more holding members configured to retain respective locking members received in the corresponding locking portions.

11. The electrical connector of claim 7, comprising:
the locking member comprising a head, a threaded portion, and a connecting portion between the head and the threaded portion, the threaded portion having a diameter greater than that of the connecting portion.

12. An electrical connector comprising:
a housing comprising an elongated portion comprising a slot, and a locking portion comprising a through-hole;
a plurality of signal terminals comprising mating portions lining against the slot in a row, mounting portions extending beyond the housing; and
a retaining member at least partially disposed in the through-hole of the locking portion of the housing.

13. The electrical connector of claim 12, wherein:
the retaining member comprises a nut disposed in the through-hole.

14. The electrical connector of claim 12, wherein:
the locking portion is an overhanging portion of the housing.

15. The electrical connector of claim 12, wherein:
the locking portion separates the slot of the elongated portion into two segments.

16. The electrical connector of claim 13, wherein:
the retaining member comprises a cover extending along a mating face of the locking portion of the housing and comprising mounting feet configured for mounting to a circuit board.

17. An electrical connector comprising:
a housing comprising a base, a tongue portion protruding from the base, and a locking portion comprising a through-hole;
a plurality of signal terminals comprising mating portions lining against the tongue portion in a row, mounting portions extending beyond the base; and
a locking feature extending in the through-hole of the locking portion of the housing.

18. The electrical connector of claim 17, wherein:
the through-hole of the locking portion of the housing is configured to receive a locking member; and
the locking feature is configured to restrain movements of the locking member.

19. The electrical connector of claim 17, wherein:
the locking feature is a beam curved in the through-hole from a conductive member disposed on the locking portion of the housing.

20. The electrical connector of claim 17, wherein:
the locking portion is an insulative beam integrally formed with the housing.
